(19) United States
(12) Patent Application Publication
(10) Pub. No.: US 2026/0371338 A1
(43) Pub. Date: Nov. 19, 2026

(54) METHOD AND APPARATUS FOR ESTABLISHING COMMUNICATION WITH A DEVICE IN CELLULAR COMMUNICATION

(71) Applicants: CENTRE OF EXCELLENCE IN WIRELESS TECHNOLOGY, Chennai (IN); INDIAN INSTITUTE OF TECHNOLOGY MADRAS (IIT Madras), Chennai (IN)

(72) Inventors: Vishakha Singh, Chennai (IN); Deepak Padmanabhan Mayakumari, Chennai (IN); Thirunageswaram Ramachandran Ramya, Chennai (IN); Jeniston Deviraj Klutto Milleth, Chennai (IN); Bhaskar Ramamurthi, Chennai (IN)

(21) Appl. No.: 19/204,285

(22) Filed: May 9, 2025

(30) Foreign Application Priority Data
May 10, 2024 (IN) 202441037186

(51) Int. Cl. H04W 72/12; H04W 56/00

(52) U.S. Cl. CPC H04W 72/12; H04W 56/0045

(57) ABSTRACT

A method for establishing communication with a device in cellular communication, comprises receiving, by at least one first node, a first trigger message, wherein the first trigger message comprises a first scheduling information for transmission, determining, by the at least one first node, plurality of resources configured for transmission, wherein determining comprises, determining a start time of a resource from the plurality of resources based on the first trigger message and using at least one time offset, wherein the start time is one of: the time obtained using the at least one time offset after the time instant of receiving one of the start of the first trigger message and the end of the first trigger message and sum of the at least one time offset after the time instant of receiving one of the start of the first trigger message and end of the first trigger message.

### CROSS-REFERENCE TO RELATED APPLICATIONS

This application claims the benefit of Indian Patent Application No. 202441037186, filed 10 May 2024 the disclosure of which is incorporated herein by reference in its entirety.

### FIELD OF THE INVENTION

The present disclosure, generally, relates to IoT networks. More particularly, the present disclosure relates to a methods and apparatus for establishing communication with an ambient IoT (A-IoT) device in cellular communication.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

IoT refers to an ecosystem of a large number of devices in which every device is connected to a wireless sensor network using low-cost self-powered sensor nodes. Ambient IoT devices, also known as ambient intelligence or ambient computing devices, are a subset of IoT devices that operate in the background, using sensors, data analytics, and connectivity to create intelligent and adaptive environments. These devices are often unobtrusive, embedded in our surroundings, and provide a continuous flow of data that can be analyzed and acted upon to improve various aspects of our lives.

In recent years, reduced capability devices with ultra-low power consumption, minimum maintenance cost, and long-life span have attracted much attention in the wireless communication world. A massive number of such devices are expected to be interconnected to improve productivity, efficiency and increase the comforts of life. Further reduction of size, complexity, and power consumption of such devices can enable the deployment of tens or even hundreds of billion devices for various applications and provide added value across the entire value chain. Further, it is impossible to power all such devices by battery that needs to be replaced or recharged manually, which leads to high maintenance cost, serious environmental issues, and even safety hazards in some use cases (e.g., wireless sensor in electric power and petroleum industry). Therefore, energy harvesting can be a potential option to power such devices, where the energy can be harvested using radio waves, light, motion, heat, or any other power source that could be seen suitable.

Radio Frequency Identification (RFID) is a well-known technology exhibiting above mentioned features. RFID supporting battery less tags has been used in many kinds of applications, such as retail and logistics and has been trialed for manufacturing logistics. However, manual scanning is needed, since the effective communication range is a few meters, which leads to labor intensive and time-consuming operations, or RFID portals/gates, leading to costly deployments. Moreover, the lack of interference management scheme results in severe interference between RFID readers and capacity problems, especially in case of dense deployment. Therefore, it is hard to support large-scale networks with seamless coverage for RFID.

Ambient IoT (A-IoT) devices are an alternate class of reduced capability devices in cellular technology. The communication range of A-IoT devices is larger compared to RFID. An A-IoT reader is expected to support a communication range of tens of meters for indoor scenarios. Further, the cellular gNB can be reused as A-IoT readers to minimize the deployment cost and cellular bands/technologies can be reused to improve performance. Furthermore, a network which scales with the number of devices or A-IoT readers should also be supported for practical deployments, and it should be able to adapt to e.g., interference between A-IoT readers to avoid the cost of complicated network planning. The use cases for A-IoT devices can be broadly classified into four categories such as tag identification, sensor monitoring, target tracking and actuator. Typical scenarios such as automated warehousing, automobile manufacturing, and medical instruments inventory management etc. Sensor monitor refers to the detection of KPI information in the surrounding environment through sensors, and then, using these data to make corresponding judgments to achieve corresponding detection purposes, including danger, disaster, and health detection and data reporting. Target tracking is an application that uses the network to obtain A-IoT device location information to locate targets, including item finding, positioning and tracking, etc. An actuator is a device that converts energy into motion. It does this by taking an electrical signal and combining it with an energy source. An actuator comes in a few different guises, including Pneumatic, Hydraulic, Electric, Thermal and Magnetic.

The A-IoT devices can be classified into the different categories based on the energy storage/signal generation capability and such category includes Passive A-IoT devices, Semi-Passive A-IoT devices or Active IoT-devices. Passive A-IoT device are pure battery less devices with no energy storage capability at all, and completely dependent on the availability of an external source of energy. These passive A-IoT devices can not generate/amplify the signal independently and operates on the backscattering transmission principle. Semi-passive A-IoT device are the devices which have battery but with limited energy storage capability. The stored energy can be used for amplification for signals which increases the communication range. The device cannot generate the signal independently and works on the backscattering transmission principle. Active A-IoT devices are devices which have batteries, which can store energy, and active RF components. Therefore, active A-IoT devices have the capability of generating/amplifying the signal independently.

Deployment of A-IoT network typically includes A-IoT reader, one or more A-IoT devices and an Intermediate node. The A-IoT reader, controls the operation of one or more A-IoT devices. An A-IoT reader can be handheld, mounted to infrastructure (e.g. base station (A-IoT reader), an User equipment (UE) etc). It may or may not be battery constrained (depending on the scenario) and can (but not necessarily need to) connect to an A-IoT server. The A-IoT reader is responsible for managing communication with the A-IoT devices. The A-IoT reader establish connection with A-IoT device, sends commands/control, collects data from the A-IoT devices, and coordinates their activities. The A-IoT reader may be connected to a larger network or the internet, enabling data exchange with other systems or cloud services. The A-IoT reader can be single entity or a group of nodes. E.g., one node can transmit the control signals in DL for the one or more A-IoT device and another node can receive the backscattered or transmitted signal from the one or more A-IoT device. A-IoT device can be attached to any object, and can connect to a A-IoT reader with A-IoT Radio. The tag may not have any active connection to an A-IoT server. Any signal/information exchange between the A-IoT device and server is via the A-IoT reader (e.g. A-IoT device signature, configuration, data reporting) and is controlled by the A-IoT reader. Further, in some cases direct communication is not possible between A-IoT reader and A-IoT device. In such cases an intermediate node may be placed between A-IoT reader and A-IoT device to improve the communication. The intermediate node can be a UE, a relay or repeater, an integrated access and backhaul node, etc. For ex., if the A-IoT reader and A-IoT device are separated by large distance, then the backscattered signal from A-Iot device may not reach the reader efficiently. In such cases a repeater, under the control of A-IoT reader, can be placed to receive signal backscattered by the A-IoT device and to forward it to reader.

Carrier wave node (CWN) is generally used to transmits carrier waves to the A-IoT devices. The A-IoT device uses carrier wave for backscattering and the energy harvesting. Based on the received carrier waves, the A-IoT device harvest energy, which can be used to perform operation of transmission and reception of data to and from A-IoT reader in the cellular communication. Further, the A-IoT device modulate the carrier wave and backscatter to A-IoT reader, based on control information from A-IoT reader. CWN can be inside the topology or it can be outside the topology. A-IoT devices mainly work on the principle of backscatter communication. The backscatter transmitter (e.g., A-IoT device) reflects the carrier wave and modifies one or more characteristics (e.g., amplitude, phase, or center frequency) of the reflected signal according to the information bits stored in its memory. Communication via back scattering instead of active radiation reduces the RF frontend of the A-IoT device (E.g. tag and sensor etc.) to a single transistor switch, which minimizes the manufacturing cost as well as energy demands.

The carrier wave can be transmitted by the A-IoT reader itself or using an external node (also known as carrier wave node (CWN)), near to the A-IoT device. In the case of A-IoT reader transmitting the carrier, the pathloss encountered by the backscattered wave is twice the distance between A-IoT reader and the A-IoT device which significantly reduces the coverage. Further, transmission of carrier wave and reception of backscattered signal happen simultaneously at the A-IoT reader, demanding full duplex operation. Also, the transmitted carrier wave interferes with the reception of backscattered signal, a.k.a. self-interference, and impacts the performance of the system. The advantage with latter method (using CWN) is reduction in pathloss and increase in coverage as the node generating carrier wave is near to the A-IoT device. Further, it reduces interference at the A-IoT reader as the A-IoT reader is only receiving from the A-IoT device.

The A-IoT device derives energy to turn on the modulating and backscattering circuitry using the energy harvesting mechanism. The energy harvesting can be performed using carrier wave, RF signal, solar energy, etc. Once the A-IoT device has harvested enough energy it turns on the circuitry, modulates the carrier wave based on the stored value and back scatter modulated carrier wave to the A-IoT reader. The energy remaining after backscattering can be stored in the A-IoT device depending on the energy storing capability of the A-IoT device. The A-IoT devices can be employed in both monostatic and bi-/multi-static configurations, where the term monostatic is used when both the CWN and the A-IoT reader functionalities are performed by the same device, while bistatic deployment specifies the scenario where the CWN and the A-IoT reader are physically two different devices.

The energy harvesting process can be continuous or discontinuous. In continuous case the device harvest energy continuously irrespective of whether communication with reader is initiated or ongoing, whereas in discontinuous case the energy harvesting starts only when communication with reader is initiated or energy storage goes below certain threshold.

In a network, an A-IoT reader is connected to multiple devices and serves all of them. Multiplexing downlink/uplink signals for multiple devices is an important aspect in communication. The signals for each device have to be multiplexed orthogonally in time/frequency/space/code domain so that the information can be decoded at the receiver. In some scenarios, the reader can configure separate resources for communicating with each device in downlink control information (DCI). However, it increases the signaling overhead especially when the number of connected devices is very high. Also, there can be scenarios where multiple devices receive broadcast information and try to respond to the broadcast information. In such cases configuring separate resources for each device may not be efficient and is impractical, leading to collision. Thus, there is a need for a method and system to minimize collision among the A-IoT devices using near orthogonal resources, and implicit methods of deriving such resources for transmission/reception of signals by the device. There is a further need for signaling methods for identification of an A-IoT device in a network.

### SUMMARY OF THE INVENTION

The summary is provided to introduce aspects related to a method of communication in a cellular network, and the aspects are further described below in the detailed description. This summary is not intended to identify essential features of the claimed subject matter nor is it intended for use in determining or limiting the scope of the claimed subject matter.

The disclosure provides a method for establishing communication with a device in cellular communications, wherein the at least one first node receives, a first trigger message, wherein the first trigger message comprises a first scheduling information for transmission. The at least one first node determines, plurality of resources configured for transmission, wherein determining comprises, determining a start time of a resource from the plurality of resources based on the first trigger message and using at least one time offset.

In an embodiment, the start time is one of: the time obtained using the at least one time offset after the time instant of receiving one of the start of the first trigger message and the end of the first trigger message and sum of the at least one time offset after the time instant of receiving one of the start of the first trigger message and end of the first trigger message. The at least one first node transmits a first message in at least one resource from the plurality of resources, wherein the first message comprises a first random number. The at least one first node receives a second message, wherein the second message comprises at least one second random number. The at least one first node transmits a third message, if the at least one second random number contains the first random number. The at least one first node receives, a first trigger message, wherein the first trigger message comprises a first scheduling information for transmission. The at least one first node determines, plurality of resources configured for transmission, wherein determining comprises, determining a start time of a resource from the plurality of resources based on the first trigger message and using at least one time offset.

In an embodiment, the start time is one of: the time obtained using the at least one time offset after the time instant of receiving one of the start of the first trigger message and the end of the first trigger message and sum of the at least one time offset after the time instant of receiving one of the start of the first trigger message and end of the first trigger message. The at least one first node transmits, a first message in at least one resource from the plurality of resources, wherein the first message comprises a first random number. The at least one first node receives, a second message, wherein the second message comprises at least one second random number. The at least one first node transmits, a third message, if the at least one second random number contains the first random number.

A method for establishing communication with a device in cellular communication in accordance with an embodiment of the present disclosure, comprises: transmitting, by at least one second node, a first trigger message comprising first scheduling information for a plurality of resources, wherein the first scheduling information comprises a first time offset indicating the start time of the plurality of resources and a second time offset indicating the start time of a resource from the plurality of resources, wherein the start time of the plurality of resources is the time obtained using the first time offset after the time instant of receiving one of the start of the first trigger message and the end of the first trigger message and wherein the start time of the resource from the plurality of resources is the time obtained using the second time offset after one of the time instant of receiving the start of the first trigger message the time instant of receiving the end of the first trigger message, and the start of the plurality of resources receiving, by the at least one second node, at least one first message in at least one resource from the plurality of resources, wherein the at least one first message comprises at least one first random number. The first node transmits a second message wherein the second message comprises at least one second random number from the at least one first random number.

In an embodiment, an apparatus for establishing communication with a device in cellular communications comprises a processor, a memory storing program instructions which, when executed by the processor, causes the processor to receive, a first trigger message, wherein the first trigger message comprises a first scheduling information for transmission. The processor determines, plurality of resources configured for transmission, wherein determining comprises, determining a start time of a resource from the plurality of resources based on the first trigger message and using at least one time offset.

In an embodiment, the start time is one of: the time obtained using the at least one time offset after the time instant of receiving one of the start of the first trigger message and the end of the first trigger message and sum of the at least one time offset after the time instant of receiving one of the start of the first trigger message and end of the first trigger message. The processor transmits a first message in at least one resource from the plurality of resources, wherein the first message comprises a first random number. The processor receives a second message, wherein the second message comprises at least one second random number. A third message is transmitted if the at least one second random number contains the first random number. A first trigger message is received, wherein the first trigger message comprises a first scheduling information for transmission. The processor determines plurality of resources for transmission, wherein determining comprises, determining a start time of a resource from the plurality of resources based on the first trigger message and using at least one time offset.

In an embodiment, the start time is one of: the time obtained using the at least one time offset after the time instant of receiving one of the start of the first trigger message and the end of the first trigger message and sum of the at least one time offset after the time instant of receiving one of the start of the first trigger message and end of the first trigger message. A first message is transmitted in at least one resource from the plurality of resources, wherein the first message comprises a first random number. A second message is received, wherein the second message comprises at least one second random number. A third message is transmitted, if the at least one second random number contains the first random number.

In an embodiment, an apparatus for establishing communication with a device in cellular communications comprises a processor, a memory storing program instructions which, when executed by the processor, causes the processor to transmit, a first trigger message comprising first scheduling information for a plurality of resources, wherein the first scheduling information comprises a first time offset indicating the start time of the plurality of resources and a second time offset indicating the start time of a resource from the plurality of resources, wherein the start time of the plurality of resources is the time obtained using the first time offset after the time instant of receiving one of the start of the first trigger message and the end of the first trigger message and wherein the start time of the resource from the plurality of resources is the time obtained using the second time offset after one of the time instant of receiving the start of the first trigger message, the time instant of receiving the end of the first trigger message, and the start of the plurality of resources, receive at least one first message in at least one resource from the plurality of resources, wherein the at least one first message comprises at least one first random number, transmit, a second message wherein the second message comprises at least one second random number from the at least one first random number.

The processor is configured to receive, at least one first message in at least one resource from the plurality of resources, wherein the at least one first message comprises at least one first random number, transmit a second message wherein the second message comprises at least one second random number from the at least one first random number.

### BRIEF DESCRIPTION OF THE DRAWINGS

The accompanying drawings are included to provide a further understanding of the present disclosure, and are incorporated in and constitute a part of this specification.

FIG. 1 illustrates an exemplary architecture which shows the connection between a reader and an A-IoT device;

FIG. 2 illustrates general block diagram of a reader and the A-IoT device in accordance with an embodiment of the present disclosure;

FIG. 3 illustrates the deployment of the A-IoT device in accordance with an embodiment of the present disclosure;

FIG. 4 illustrates the random-access channel (RACH) process for establishing a connection between the one or more A-IoT devices and the reader in accordance with an embodiment of the present disclosure;

FIG. 5 illustrates a signal flow diagram between the reader and the device for establishing communication in accordance with an embodiment of the present disclosure;

FIGS. 6A and 6B illustrates a timing diagram at which A-IoT device receives and transmits the message during the RACH process in accordance with an embodiment of the present disclosure. ;

FIG. 7 illustrates a method for establishing communication by a first node according to an embodiment of the present disclosure;

FIG. 8 illustrates a method for establishing communication by a second node according to an embodiment of the present disclosure;

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

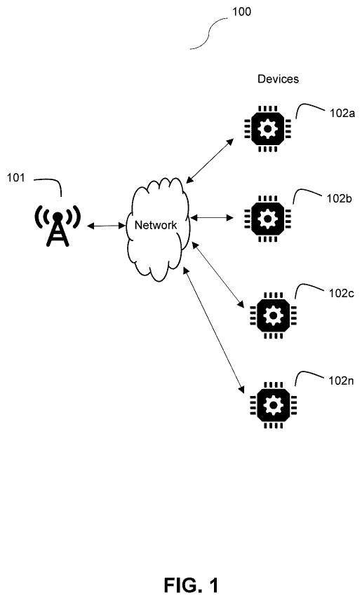

An exemplary system 100 is illustrated in FIG. 1 which shows that a reader 101 is wirelessly coupled to one or more devices 102a . . . 102n (collectively referred to as 102). In an embodiment, one or more devices 102 are connected to the reader 101 and information is transmitted, backscattered and received between the reader 101 and the device 102. The reader 101 is responsible for managing communication with the devices 102 and serves as a reader that collects data from the devices 102, sends commands, and coordinates their activities. The reader 101 may be connected to a larger network or the internet, enabling data exchange with other systems or cloud services. In an embodiment, the reader is any one of a handheld device, a base station, a use equipment (UE), Network-Controlled Repeater (NCR), Integrated Access and Backhaul (IAB), repeater, or any combination thereof. In another embodiment, the device is at least one of an ambient IoT device and IoT device. In a further embodiment, the ambient IoT devices is any one of passive IoT device, Semi-passive IoT device, or Active A-IoT device or any combination thereof.

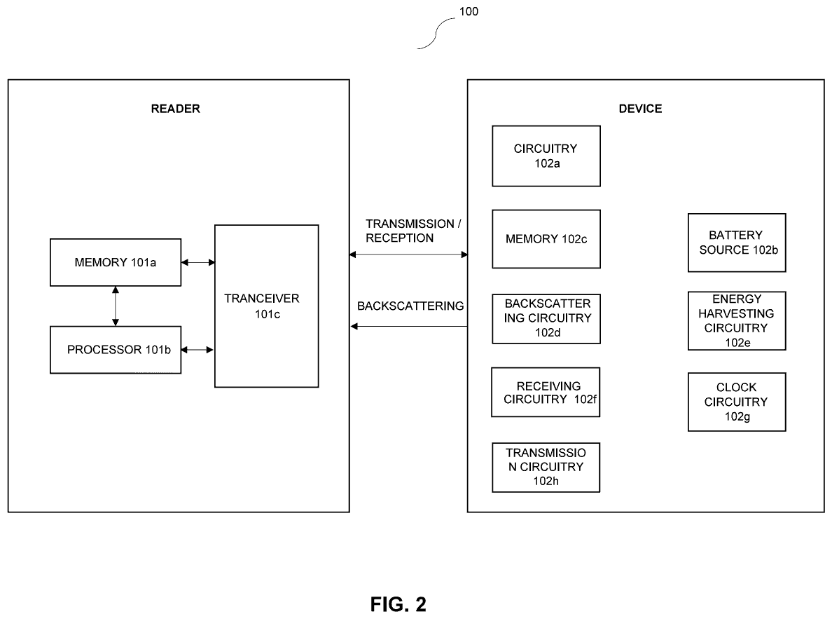

FIG. 2 illustrates a general block diagram of the reader 101 and the device 102 according to an embodiment of the present disclosure. The reader 101 comprises a memory 101a, a processor 101b and a transceiver 101c. In an example, the processor 101b includes a processor(s) that may be a single processing unit or a number of units, all of which could include multiple computing units. The processor 101b may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 101b is configured to fetch and execute computer-readable instructions and data stored in the memory 101a. The memory 101a may include any non-transitory computer-readable medium known in the art including, for example, volatile memory, such as static random-access memory (SRAM) and dynamic random access memory (DRAM), and/or non-volatile memory, such as read-only memory (ROM), erasable programmable ROM, flash memories, hard disks, optical disks, and magnetic tapes. The memory 101a and the processor 101b are coupled to the transceiver 101c for sending and receiving the data/information from the one or more devices 102.

In an embodiment, the device 102 comprises a circuitry 102a and/or a battery source 102b. The circuitry 102a may be provided as a hardware component such as one or more microprocessors, microcomputers, microcontrollers, digital signal processors, central processing units, state machines, logic circuitries, and/or any devices that manipulate signals based on operational instructions. In an embodiment, the devices are equipped with a battery source 102b. Further, the device may comprise a memory 102c which for example, may comprise device ID or pre-configured information. In a further embodiment, the device 102 comprises a backscattering circuitry 102d, an energy harvesting circuitry 102e, a receiving circuitry 102f, a clock circuitry 102g and a transmission circuitry 102h.

The presence of battery source 102b helps in signal amplification or even independent Radio Frequency signal generation. The batteries 102b also allow for greater flexibility, including mobility in their deployment, as they are not dependent on external energy sources. However, efficient power management is crucial to extend the operational lifespan of these devices, as replacing batteries in large-scale deployments can be costly and sometimes become impractical. This topology is commonly employed in applications such as environmental monitoring, asset tracking, and industrial automation, command, and positioning, where the reader and devices work together to collect and transmit data for analysis and decision-making.

The battery based devices are mainly used in the outdoor scenarios or where the distance between reader and the devices is large. The device needs to connect with reader, and it has to synchronize in downlink as well as in uplink. The Downlink and Uplink synchronization, called as initial access procedure refers to the process a device follows to establish a connection with a reader. This procedure is crucial for allowing the device to access the network and start using its services.

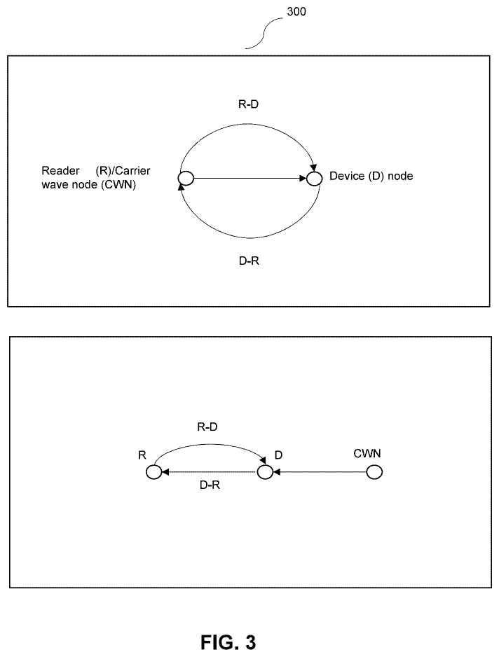

FIG. 3 illustrates the deployment 300 of the A-IoT device in accordance with an embodiment of the present disclosure. Deployment of A-IoT device can include the A-IoT reader, A-IoT device, carrier wave node. The A-IoT device can be a tag, attached to any passive device, active device, sensor, or it can be UE, NCR, IAB etc. The A-IoT reader, or simply reader, controls the operation of the A-IoT device. A reader can be handheld, mounted to infrastructure (e.g. base station (BS), user equipment (UE), a network controlled repeater (NCR), integrated access and backhaul (IAB) etc etc. It may or may not be battery constrained (depending on the scenario) and can (but not necessarily need to) connect to an A-IoT server. The reader is responsible for managing communication with the A-IoT devices. The reader establishes connection with A-IoT device, sends commands/control, collects data from the A-IoT devices, and coordinates their activities. The A-IoT reader may be connected to a larger network or the internet, enabling data exchange with other systems or cloud services.

In an embodiment, the A-IoT device, or simply device, can be attached to any object, and can connect to a reader device with an A-IoT radio. The tag may not have any active connection to an A-IoT server. Any signal/information exchange between the A-IoT device and the server is via the reader device (e.g. A-IoT device signature, configuration, data reporting) and is controlled by the reader.

In an embodiment, the A-IoT devices which are not capable of generating its of transmission signal work on the principle of backscatter communication. The backscatter transmitter reflects the carrier wave and modifies one or more characteristics (e.g., amplitude, phase, or center frequency) of the reflected signal according to the information bits stored in its memory. Communication via back scattering instead of active radiation reduces the RF frontend of the device to a single transistor switch, which minimizes the manufacturing cost as well as energy demands. The node which transmits carrier waves is known as carrier wave node (CWN). CWN can be BS, UE, NCR, IAB or any other active RF device. The time resources can be any time unit like symbol/slot/chip length. The carrier wave can be transmitted by the reader or an external node near to the A-IoT device. In the case of reader acting as CWN, the pathloss encountered by the backscattered wave is twice the distance between reader and the A-IoT device which significantly reduces the coverage. Further, transmission of carrier wave and reception of backscattered signal happen simultaneously at the reader, demanding full duplex operation. Also, the transmitted carrier wave interferes with the reception of backscattered signal, a.k.a. self-interference, and impacts the performance of the system. The advantage with latter method is reduction in pathloss and increase in coverage as the CWN is near to the A-IoT device. Further, it reduces interference at the reader as the reader is only receiving from the A-IoT device.

The A-IoT device derives energy to turn on the modulating and backscattering circuitry using the energy harvesting mechanism. The energy harvesting can be performed using carrier wave provided externally using a CWN, RF signal, solar energy etc. Once the device has harvested enough energy it turns on the circuitry, modulates the carrier wave based on the stored value and back scatter modulated carrier wave to the reader. The energy remaining after backscattering can be stored in the device depending on the energy storing capability of the device. The energy harvesting process can be continuous or discontinuous. In continuous case the device harvest energy continuously irrespective of whether communication with reader is initiated or ongoing, whereas in discontinuous case the energy harvesting starts only when communication with reader is initiated or energy storage goes below certain threshold.

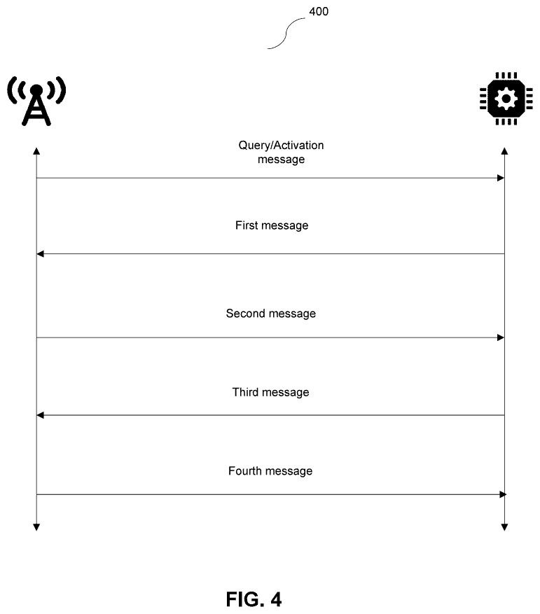

FIG. 4 illustrates the random-access channel (RACH) process 400 for establishing a connection between the one or more A-IoT devices and the reader in accordance with an embodiment of the present disclosure. In a network, an A-IoT reader is connected to multiple devices and serves all of them. Multiplexing downlink/uplink signals for multiple devices is an important aspect in communication. The signals for each device have to be multiplexed orthogonally in time/frequency/space/code domain so that the information can be decoded at the receiver. In one embodiment, the reader can configure separate resources for communicating with each device in downlink control information (DCI). However, it increases the signaling overhead especially when the number of connected devices is very high. Also, there can be scenarios where multiple devices receive broadcast information and try to respond to the broadcast information. In such cases configuring separate resources for each device may not be efficient and is impractical, leading to collision. E.g., the random-access channel (RACH) process: RACH stands as a crucial mechanism for facilitating the identification and connection establishment between A-IoT devices and the reader. The RACH process can be either a two-step (2-step RACH) or a four-step (4-step RACH) procedure.

In the 4-step RACH procedure as shown in FIG. 4, an A-IoT reader transmits a trigger or a query message to an A-IoT device which can act as an activation signal. Upon receiving the trigger signal, the A-IoT device determine a preamble/random number, based on the information in the query, and transmits a first message to the reader, where the first message comprises of preamble, information about a randomly generated number, identity of the device, etc. The resources for transmitting the first message are derived by the device depending on the information in the query and the preamble/randomly generated number. The reader receives the first message, identifies the information transmitted in the first message and transmits second message to A-IoT device, where the second message comprises acknowledgement for successfully receiving the first message, information about the content of the first message received and scheduling information for subsequent uplink transmission from device, etc. The A-IoT device receives the second message, decodes the contents, determines that the second message is intended for it and transmits its ID in third message according to the scheduling information in second message.

In an embodiment, upon receiving third message, the reader identifies the ID of the device trying to connect to the network, stores the information about the new device, declare identification success for the device and transmits the acknowledgement along with the decoded device ID in fourth message to the A-IoT device. The A-IoT device receives the fourth message, determines whether the ID contained in the fourth message matches its ID and if a match is found then declares the identification as success. The reader can initiate communication with a successfully identified device.

In an embodiment, ae 2-step RACH process can be used instead of the 4-step RACH to reduce latency in the device identification. In the 2-step RACH, the identification is completed in 2 steps. An A-IoT reader transmits a trigger or query message to initiate the 2-step RACH procedure. Upon receiving the trigger signal, the A-IoT device responds back by transmitting the first message to the A-IoT reader. Upon receiving the first message, the A-IoT reader transmits the downlink signal and if the A-IoT device decodes the downlink signal successfully then it declares that the RACH process is completed successfully. The benefit of 2 step RACH is that it requires less time with reduced overhead to complete the process.

The RACH procedure is initiated by a reader to identify a new device trying to connect to the network. Therefore, the trigger/query is broadcast by the reader and is received by multiple devices. Upon receiving the trigger/query, multiple A-IoT devices may respond back by transmitting first message to the reader. The resources in which the first message is transmitted by multiple devices, can be the same (E.g., same time and frequency resources and/or with same preamble/randomly generated number etc.), leading to collision/contention among the A-IoT devices. When the reader simultaneously receives first message from the multiple A-IoT devices, the reader must perform contention resolution and select one A-IoT device. The remaining A-IoT devices must wait for the next RACH cycle and monitor for the trigger/query. Therefore, contention introduces waiting period and additional delay at the device in establishing the connection with the reader. Therefore, the present disclosure simplifies the RACH process to minimize the delay. It is to be understood that the messages or communication from the device to the reader forms part of an uplink communication and the messages or communication from the reader to the device forms part of the downlink communication.

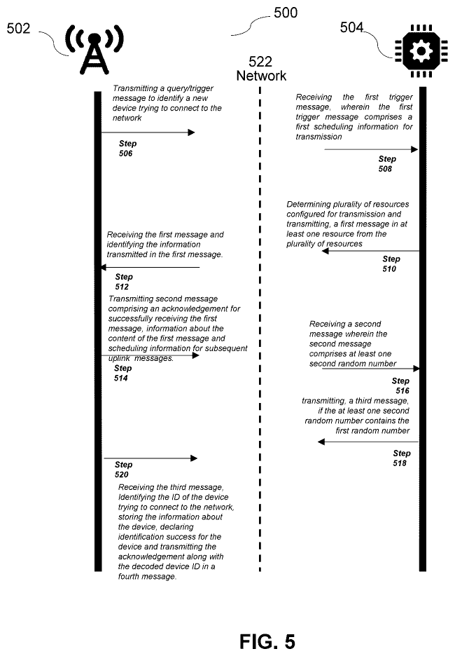

FIG. 5 illustrates a signal flow diagram 500 between the reader and the device for establishing communication with a device in cellular communication in accordance with an embodiment of the present disclosure. In an embodiment, the method described herein minimizes collision among the devices using near orthogonal resources, and further discloses implicit methods of deriving such resources for transmission/reception of signals by the device. Signalling methods for identification of an A-IoT device in a network is disclosed in accordance with an embodiment of the present disclosure. The identification can be performed by the reader at regular intervals to get information about the new devices introduced in the system or devices which were not active for a long period of time.

In an embodiment, when multiple devices transmit their uplink signal to the reader, the devices should use near orthogonal resources in time, frequency, or code for transmission of their uplink signal to minimize the collision arises due to simultaneous transmission as explained above. However, if these devices transmit their uplink signal using the same resources simultaneously, it results in collisions among the devices. Due to the collisions, the reader can't decode the received signal from the device. Thus, it is necessary for the devices to transmit their uplink signal using the orthogonal resources and ensure collision free communication between the reader and the devices or near orthogonal resources to minimize the collisions. To determine such orthogonal resources for transmission of uplink signal by the devices, the following methods are disclosed.

At steps 506 and 508, when the query message or any downlink signal is received by devices from the reader within range, it responds accordingly. The query message may include information such as a first integer value (K), preamble, a second integer value (S), and a set of frequency resources and time resources for transmissions and receptions of the subsequent messages. The set of frequency and time resource can be indicated as a function of centre frequency, the bandwidth and the time offset to receive and transmit downlink and uplink signals. The preamble can be used as temporary identification for the device. K and S values are used to identify the time resources.

At step 510, the orthogonal resources are determined for transmission of uplink signal by the devices in accordance with an embodiment of the present disclosure. In one embodiment, the slot/time resource for uplink transmission can be selected based on the device ID. In one embodiment, the device ID can be a unique number that can be hard coded in the device at the time of manufacturing, where the unique number can be a binary, integer or an alpha numeric number. In other embodiments, the device ID can be configured at the time of the deployment and which can be indicated by the network to the reader or the device ID can be configurable by the reader during the transmission and reception of downlink and uplink data.

In an embodiment, the MSB/LSB bits of a device ID can be used to determine the slot/time instance to transmit the query response (first message) by the device. For example, if the device ID is defined by bits bₙb_{n-1 . . .} b₂b₁ where bₙ corresponds to MSB and b₁ corresponds to LSB, then the device generates the slot number/time instance based on last k LSB bits i.e., bₖbₖ−1 . . . b₁. Based on the above, if k is defined as 4 and if last k bits of the device ID of an device are 0110, then the corresponding device generates a decimal equivalent of 0110 i.e., 6 as the slot/time index. Accordingly, each device generates the different time index if all MSB/ LSB bits are different in the device ID, the different generated time resources to ensure the orthogonal resources for transmitting the uplink of multiple device to avoid to collisions and if the time indices are not different then collisions will be present and this occurrence must be minimized to reduce the collisions.

In another embodiment, the device ID is used to find out the time instances to transmit the uplink transmission from the multiple devices to minimize the collision among the devices, the device ID can be a decimal equivalent number. The function of device ID can be used as a slot number/time instances to transmit the uplink transmission as a response to the query by the device. If device ID is X, and Y be a maximum response time window in which the device sends its uplink signal and reader waits for receiving the uplink signal, then the slot number/time resource Z(X) is obtained as Z (X)=F(X) mod Y. Where, F(X) is an integer number equivalent of X. The value of Y can be predefined in the standards, or it can be configured by the reader.

In a further embodiment, when the reader transmits the query message to multiple devices, each device responds with an uplink signal. To determine the orthogonal time resources, the reader transmits the control information in the query message such as two integer values (K, S) as defined above. These integer values are used to determine the time resources for transmitting the uplink transmission. The device generates a random number using the K value. The random number value can be picked in the range of (0, 2K−1). After generating random number, the device generates the step size using S value from the range of (0, N). N can be an integer value and it is used to define the upper bound of the step size in the range.

The value of N can be predefined in specification, or it can be configured by the reader. The randomly generated number can be loaded into the device slot/time counter. Once the timer is assigned with the generated random number, there can be two ways of determining the time resources to transmit the query response (first message). In one option, the slot counter/time counter can be decremented to zero using generated step size and once it reaches zero, the device transmits the query response to the reader in accordance with an embodiment of the present disclosure.

In another embodiment, the slot counter/time counter can be decreased/increased by “n” (where n is the integer value) number of step size and the decremented/incremented slot/time counter number can be used as a time resource to transmit the query response. The value of the n can be indicated by the reader in the query, or it can be predefined in the specification. In the above embodiment as disclosed, the devices can generate different step sizes with different generated number which results in orthogonal resources like different slot/time instances which can minimize the collision of transmitting query response by the multiple devices at a same time. Since two values are generated randomly, the probability of generating two same random values is significantly less thereby reduces collision. For e.g. if two device generates the same random number but still there can be probability of generating different step size. Thus, the embodiments described herein reduces the collisions among devices.

RACH process is used for identification of the A-IoT device as previously disclosed. The reader transmits the system and scheduling information during the RACH process to the A-IoT devices to transmit their messages. The scheduling and system information can be common or dedicated for each device based on transmission time to the A-IoT devices. For e.g. if the information is shared after the identification or once the RACH procedure is completed, then this information can be device specific.

In an embodiment, the information carried by the different messages during the RACH procedure and the timing relationship with respect to the messages of the RACH procedure are discussed. The different messages can contain different signalling information based on use cases and the device capability for device identification and establishing the connection with the A-IoT reader. The A-IoT devices with backscattering principle, require the carrier wave to backscatter the first message and the third message to the A-IoT reader in case of a 4-step RACH and for transmitting an uplink signal in case of a 2-step RACH. The transmission of the carrier wave depends on the time and frequency resources used for transmitting the messages from the A-IoT device to the A-IoT reader during the RACH process. Therefore, carrier waves should be available at the time of transmitting the different messages from the A-IoT device.

In an embodiment, a first message is transmitted from the A-IoT device to the A-IoT reader, and it can carry at least one of the following types of information: preamble and randomly generated number or device ID and/or the acknowledgement The preamble can be used to further identify the device. This can be a temporary ID for the device. The preamble is indicated in the query, or the query can indicate the index of a preamble, from a predefined pool of preambles. The centre frequency and the band of operation used for transmitting the first message can be same as the centre frequency and the band of operation used for receiving the query it can be indicated in the query as a scheduling/control information from the reader to the A-IoT device. The randomly generated number is used by the device to select the time resources by allocating the randomly generated number to a slot/any time unit counter. This randomly generated number can also work as a temporary ID for the device till it transmits its own ID to the A-IoT reader and this is also used to find out the time resources for the uplink transmission of the A-IoT device. The acknowledgement is optional which is sent for successfully receiving the query message. The centre frequency and the band of operation used for transmitting the uplink signal can be same as the centre frequency and the band of operation used for receiving the query and it can be indicated in the query as a scheduling/control information from the reader to the A-IoT device.

In an embodiment, the device ID may be sent instead of the preamble: This can be useful in the 2-step RACH where A-IoT device transmit its device ID and in response, reader will send back the device ID and/or the acknowledgement for device identification. Transmitting device ID in the first message can be useful in the case of when A-IoT device tries to reconnect with the A-IoT reader due to lost connection or low power at the device. The centre frequency and the band of operation used for transmitting the first message can be same as the centre frequency and the band of operation used for receiving the query and it can be indicated in the query as a scheduling/control information from the reader to the A-IoT device.

At steps 512 and 514, upon receiving the first message, the A-IoT reader transmits the second message to the A-IoT device. The second message can carry at least one of the following types of information: device ID and/or the acknowledgement. Transmitting device ID can be useful in the case of 2-step RACH process. At step 516, once an A-IoT device receives the device ID from the reader in a second message, it compares the received ID with its own ID for identity verification. If both IDs are same, then the RACH process is completed otherwise, it is considered as a RACH failure, and it will follow the procedure of RACH failure to proceed further.

In an embodiment, it can carry the received random number from the first message and the acknowledgement. This randomly generated number can also work as a temporary ID for the device till it transmits its own ID to the reader and this is also used to find out the time resources for the uplink transmission of the A-IoT device. Once A-IoT device receives the random number it verifies with its transmitted random number in the first message. Once this is verified at the A-IoT device that both random numbers are same in the first message and the second message, then device transmits its ID in the third message. The Acknowledgement can be optional and transmitted in second message for successfully receiving the first message. It can carry the preamble and/or acknowledgement. In second message, the reader transmits the same preamble it has received in the first uplinks signal. At step 518, once it is verified at the A-IoT device that both the preambles are same in first message and the second message, then the A-IoT device transmits its ID in a third message.

In an embodiment, the second message along with the random number/preamble/device ID, can carry system information such as operating band, bandwidth, amplification factor, transmit power, the CRC bits to generate the CRC polynomial, ON-OFF pattern of device, periodicity to monitor for trigger/control, scheduling for third message, etc. The scheduling information such as frequency resources like center frequency, sub band configuration and frequency shift for transmitting the third message and/or further transmissions and receptions after the RACH procedure is completed for the A-IoT device. The frequency shift can be applied from the center frequency of the second message or from the carrier wave center frequency in the given band of operation by the A-IoT device. In the given sub-band, the center frequency can be fixed like always a middle frequency or can be configured by the A-IoT reader. In the above mentioned ON-OFF pattern of the device, the ON pattern is defined as the time period to receive/transmit the messages from/to A-IoT reader and the time period for which device is active. In the OFF period, the A-IoT device can go in sleep mode, or it can be used to charge its battery using energy harvesting methods. This pattern can be same as the clock duty cycle, or it can be predefined in the specification, or it can be configured as mentioned above in the system information. This ON-OFF pattern can be the same during the complete RACH procedure and later it can be changed by the A-IoT reader for subsequent transmissions and receptions. The system information can also carry the pattern used for delimiter in all transmissions and receptions. The delimiter is used in downlink/uplink transmission to indicate the start of the downlink/uplink transmission to the A-IoT device, and it is a sequence/pattern (e.g. four rising edges followed by the four falling edges of the clock). Upon receiving the second message, the A-IoT device transmits third message to the reader. The scheduling information received in the second message can be used to transmit the third message.

In an embodiment, the third message can carry at least one of the following types of information. If an A-IoT device receives the same random number/preamble as transmitted in the second message, then it will transmit its ID and/or acknowledgement after verification. A-IoT devices can report its capability or device type along with its ID to device specific operations. It can carry a request to transmit the system and scheduling information for subsequent UL and DL transmissions and receptions. This system information can be used for the transmission/reception after the RACH process is done. Upon receiving third message, the A-IoT reader transmits fourth message to the A-IoT device.

In an embodiment, the fourth message can carry at least one of the device ID and/or acknowledgement and scheduling and system information. At step 520, once the device receives the ID in a fourth message then it verifies with its own ID and if it is verified then it declares that the RACH is successfully completed, otherwise declares it as a RACH failure. The fourth message can carry the scheduling and system information such as frequency (operating band, bandwidth, sub band configuration and frequency shift (the frequency shift can be applied from the centre frequency of the second message or from the carrier wave centre frequency in the given band of operation by the A-IoT device)) and time resources for the subsequent downlink and uplink transmission, amplification factor, transmit power, the CRC bits to generate the CRC polynomial, ON/OFF sleep pattern for the A-IoT device which can be applied after the completion of the RACH and monitoring pattern for the control signal or periodic synchronization signal.

The control signal can be used to indicate the resources for the subsequent UL transmissions by the A-IoT reader to the A-IoT device. The periodic synchronization can be used for periodically readjusting the alignment with the A-IoT reader due to which A-IoT device can maintain the synchronization for the longer time period. The monitoring pattern for the control signal or periodic synchronization signal can be defined as the periodicity of the signal, the time resources like a time window of the signal etc.

The ON period is used to receive/transmit the messages from/to A-IoT reader and the time period for which device is active. In the OFF period, the A-IoT device can go in sleep mode, or it can be used to charge its battery using energy harvesting process. This pattern can be same as the clock duty cycle, or it can be predefined in the specification, or it can be configured as mentioned above in the system information. This ON-OFF pattern can be the same during the complete RACH and later it can be changed by the A-IoT reader for the subsequent transmissions and receptions. The system information can also carry the pattern used for delimiter in all transmissions and receptions. The delimiter is used in downlink/uplink transmission to indicate the start of the downlink/uplink transmission to the A-IoT device, and it is the sequence/pattern (e.g. four rising edges followed by the four falling edges of the clock).

After receiving the fourth message from the A-IoT reader, the A-IoT device can send request for on-demand system and scheduling information for subsequent uplink and downlink transmissions and receptions with/without acknowledgement. The on demand scheduling and system information is same as discussed above.

As previously discussed, the RACH can be two types. In one type, all the above four messages need to be transmitted and received from/to the A-IoT reader and A-IoT device respectively for identifying the A-IoT device in the 4 step RACH process. The on-demand request for scheduling and the system information can be transmitted by the A-IoT device for transmission and reception. In another type, only first message and second message are to be transmitted and the received from/to reader and A-IoT device respectively for identifying the A-IoT device in the 4-step RACH process. The on-demand request for scheduling and the system information can be transmitted by the A-IoT device for transmission and reception.

In an embodiment, the A-IoT reader may select the 2-step RACH process or the 4-step RACH process based on the energy storage of the device, use cases like inventory, sensor, positioning and command, device capability, whether device is participating for the first time in identification process i.e., new device or device need to reconnect because of the lost connection with the A-IoT reader. The behavior of the A-IoT device depends on the type of operation, like normal transmission of the data (command to follow) and control (which carries the scheduling information for downlink and/or uplink) after the device is identified and the synchronization process like RACH. To enable the A-IoT device to identify whether the operation is transmission of data/control or the RACH operation, either explicit signalling or implicit signaling can be used. The implicit method is based on size or payload of the message. e.g., the payload or the size for the triggered/query message can be fixed and can be made specific to the RACH so that on receiving it device will identify it as query or the message to initiate RACH.

In an embodiment, the explicit indication of one bit can be given in the preamble or can be a part of the control signal in the query or any activation signal from reader to A-IoT device. The indication can indicate whether the packet is for RACH process or for normal transmission and reception after the RACH process is completed.

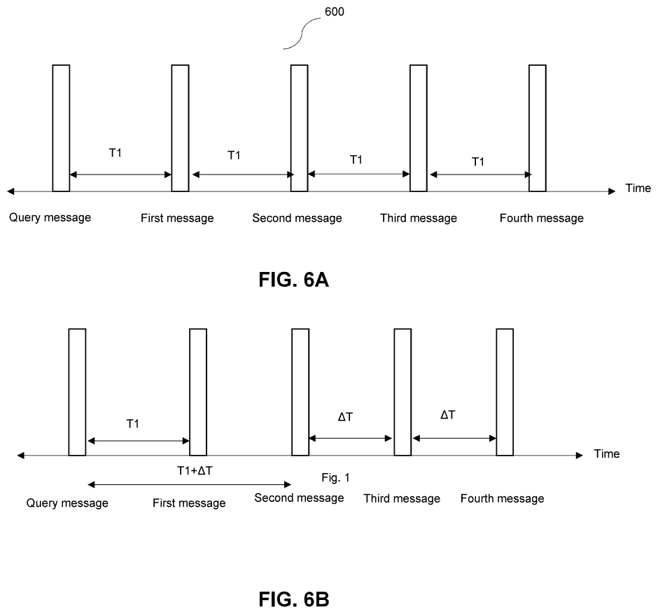

FIGS. 6A and 6B illustrates a timing diagram 600 at which A-IoT device receives and transmits messages during the RACH process in accordance with an embodiment of the present disclosure. In one embodiment, the time duration between all the messages after receiving the query messages can be predefined in the specification and configured by the A-IoT reader to the A-IoT device in the scheduling and system information as shown in FIG. 6A. As shown in FIG. 6A, the query message is received at time instance ‘T0’ and the first message is transmitted by the device after time duration T1 from T0. The duration T1 can be predefined in standards/specification, and it can depend on the distance between the A-IoT device and the A-IoT reader, processing time of the A-IoT device etc. The same T1 time duration can be maintained between all the uplink and downlink signals as shown in FIG. 6A.

In another embodiment, the time T1 can be given in the query message for transmitting first message, by the A-IoT reader to the A-IoT device as shown in FIG. 6B. The value of T1 can be configured by the A-IoT reader. To receive the second message, a fixed offset can be applied from the T1 instance, or the offset can be given in the query as well to receive and transmit the subsequent messages during RACH procedure. The time duration can be defined in terms of symbol/slot/chip length and any time unit.

In an embodiment, the behavior of the A-IoT device can differ based on the successfully received or transmitted messages during the RACH process. In a first scenario, when an A-IoT device transmits the first message in response to the received query message and the downlink signal is not received during the monitoring period by the A-IoT device, the following device behaviours can be considered: The device can increase the monitoring period by an additional waiting period. The waiting period can be a fixed time period predefined or configured by the A-IoT reader in the query. If an A-IoT device receives the second message during the waiting period, then it can proceed further for transmitting the third message. In one embodiment, the A-IoT device can declare it as RACH failure and restart the monitoring for the query message.

In another embodiment, A-IoT device can retransmit the first message to the A-IoT reader and then wait for receiving the second message. In this method, the A-IoT device can retransmit the first message using different/same time and/or frequency resources and randomly generated number. The maximum number of retransmissions can be fixed. If the device is not receiving any second message after the maximum number of retransmissions of the first message then the device has to declare it as a RACH failure and start monitoring for query again in the next RACH process cycle. The maximum number of retransmissions of the first message can be predefined or it can be configured by the A-IoT reader. In another embodiment, it can restart the monitoring of the query message for further reception and transmission of the messages of RACH.

In an embodiment, when the fourth message is not received by the A-IoT device in the monitoring period, the following solutions are proposed: The device can increase the monitoring period by an additional waiting period. The waiting period can be as fixed time period predefined or configured by the A-IoT reader in query. If an A-IoT device receives the fourth message during the waiting period, then the RACH procedure is completed, and it may further request to reader for the system information called as on demand system information. In another embodiment, the A-IoT device can declare it as a RACH failure and restart the monitoring for the query message.

In another method, the A-IoT device can retransmit the third message to the A-IoT reader and then wait for receiving the fourth message. In this method, the A-IoT device can retransmit the third message using different/same time and/or frequency resources and randomly generated number. The maximum number of retransmissions can be fixed. If the device does not receive any fourth message after the maximum number of retransmissions of the third message then the device has to declare it as a RACH failure and start monitoring for query again in the next RACH process cycle. The maximum number of retransmissions of third message can be predefined or it can be configured by the reader.

In an embodiment, when carrier wave is not received by the A-IoT device at the time of backscattering the first message and third message during RACH process, the time window with multiple transmission occasions can be defined for receiving the carrier wave by the A-IoT device. In this time window, the A-IoT reader can transmit the carrier wave at multiple predefined occasions to the A-IoT device. If the A-IoT device does not receive any carrier wave in the defined time window, then it can restart the RACH process in the next cycle. The maximum number of occasions for transmitting the carrier wave can be fixed or configured by the reader.

Thus, the embodiments described herein throughout this disclosure provides for a simpler RACH process compatible for A-IoT devices based on the capability of the A-IoT devices.

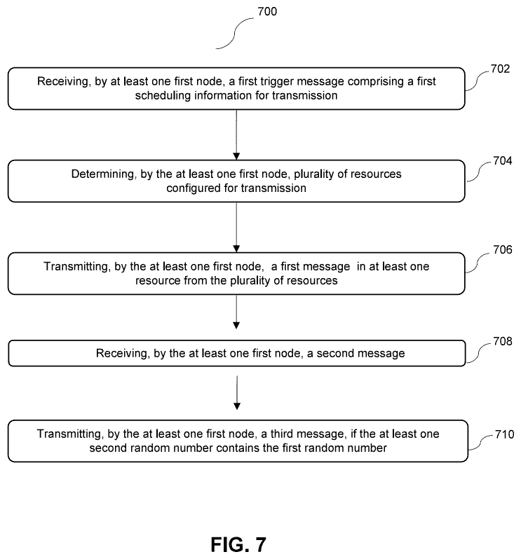

FIG. 7 features a method 700 for establishing communication by a first node. wherein the at least one first node receives, a first trigger message, wherein the first trigger message comprises a first scheduling information for transmission. The at least one first node determines, plurality of resources configured for transmission, wherein determining comprises, determining a start time of a resource from the plurality of resources based on the first trigger message and using at least one time offset.

In an embodiment, the start time is one of: the time obtained using the at least one time offset after the time instant of receiving one of the start of the first trigger message and the end of the first trigger message and sum of the at least one time offset after the time instant of receiving one of the start of the first trigger message and end of the first trigger message. The at least one first node transmits a first message in at least one resource from the plurality of resources, wherein the first message comprises a first random number. The at least one first node receives a second message, wherein the second message comprises at least one second random number. The at least one first node transmits a third message, if the at least one second random number contains the first random number. The at least one first node receives, a first trigger message, wherein the first trigger message comprises a first scheduling information for transmission. The at least one first node determines, plurality of resources configured for transmission, wherein determining comprises, determining a start time of a resource from the plurality of resources based on the first trigger message and using at least one time offset.

In an embodiment, the start time is one of: the time obtained using the at least one time offset after the time instant of receiving one of the start of the first trigger message and the end of the first trigger message and sum of the at least one time offset after the time instant of receiving one of the start of the first trigger message and end of the first trigger message. The at least one first node transmits, a first message in at least one resource from the plurality of resources, wherein the first message comprises a first random number. The at least one first node receives, a second message, wherein the second message comprises at least one second random number. The at least one first node transmits, a third message, if the at least one second random number contains the first random number.

In an embodiment, the at least one of the at least one time offset is at least one of received time offset explicitly, implicitly derived using another received time offset and predefined. The one of transmission and reception of plurality of messages comprises transmitting and receiving consecutive messages from the plurality of messages with a fixed time offset.

In an embodiment, the first random number is generated based on the first trigger message. The at least one resource is determined based on generating a third random number, assigning the third random number to a timer counter, one of decrementing and incrementing the timer counter and determining the at least one resource from the plurality of resources at the expiry of the timer counter. Generating the third random number is based on one of: the first trigger message and at least one bit in the identity of the at least one first node,

In an embodiment, determining the at least one resource comprises mapping the value of the timer counter as the at least one resource, wherein the mapping is one of predefined and signaled using at least one of RRC, MAC-CE and DCI. Mapping the resources is one of counting the frequency domain resources followed by the time domain resources and counting the time domain resources followed by frequency domain resources, wherein one of decrementing and incrementing the timer counter is based on a step size.

In an embodiment, the first trigger signal comprises at least one information to generate the third random number, wherein the at least one information to generate the third random number comprises at least one of a first integer value and a second integer value. The first integer value is used for generating at least one of length of the third random number and a range for selecting the third random number. The second integer value is used for generating a range for selecting a step size.

In an embodiment, determining the at least one resource is based on an identity of the at least one first node, wherein the identity is one of a decimal value and plurality of the bits. The at least one bit in the identity maps to the at least one resource.

In an embodiment, the time offset in the at least one time offset is at least one of predefined, explicitly indicated in the first trigger message and implicitly derived. The at least one time offset is the minimum time duration between at least one of: a reception and the subsequent transmission and two consecutives transmissions. The first message further comprises at least one of a preamble, a first feedback message and identity of the at least one first node, wherein the first feedback message is in response to reception of the first trigger message. The first feedback message is one of positive acknowledgment and negative acknowledgement.

In an embodiment, the first feedback message comprises an ACK when the reception of the first trigger message is successful and a NACK when the reception of the first trigger is unsuccessful.

In an embodiment, the preamble is from plurality of preamble received in the first trigger message. The first message is transmitted in at least one resource in which the first trigger message is received.

In an embodiment, the second message further comprises at least one of: a second scheduling information for the third message, a second feedback message, identity of the at least one first node and at least one preamble, wherein the second feedback message is in response to transmission of the first message. The second feedback message is one of positive acknowledgment and negative acknowledgement. The second feedback message comprises an ACK when the transmission of the first message is successful and a NACK when the transmission of the first message is unsuccessful.

In an embodiment, the third message transmitted is in the at least one resource, wherein transmitting the third message is in the at least one resource, when the second scheduling information for the third message is absent in the second message. The third message comprises at least one of: identity of the at least one first node, at least one capability of the at least one first node, a third feedback message, a type of the at least one first node and a first scheduling request to transmit a third scheduling information for at least one of DL reception and UL transmission. The third feedback message is in response to reception of second message, wherein the third feedback message is one of positive acknowledgment and negative acknowledgement.

In an embodiment, the third feedback message comprises an ACK when the reception of the second message is successful and a NACK when the reception of the second message is unsuccessful.

In an embodiment. the at least one first node receives, a fourth message, wherein the fourth message comprises at least one of: identity of the at least one first node, a fourth feedback message, and an fourth scheduling information for at least one of DL reception and UL transmission. The fourth feedback message is in response to transmission of the third message, wherein the fourth feedback message is one of positive acknowledgment and negative acknowledgement. The fourth feedback comprises an ACK when transmission of the third message is successful and a NACK when the transmission of the third message is unsuccessful.

In an embodiment, receiving comprises receiving at least one of: a first pattern to indicate the start of at least one of DL reception and UL transmission, a clock to adjust the timing alignment between the at least one first node and the second node and a second pattern to indicate the bit duration. The receiving comprises receiving an ON-OFF pattern that determines the operational time at which the device receives and transmits the message during the RACH process.

In an embodiment, obtaining the time comprises, determining start of the plurality of resources by applying at least one first time offset after the time instant of receiving one of the start of the first trigger message and end of the first trigger message and determining a resource from plurality of resources by applying at least one second time offset after the time instant of the start of the plurality of resources. The at least one of the at least one first time offset and the at least one second time offset is at least one of received time offset explicitly, implicitly derived and predefined.

In an embodiment, a second scheduling request is transmitted to transmit a fifth scheduling information, wherein one of the first scheduling information, the second scheduling information, the third scheduling information, the fourth scheduling information and fifth scheduling comprises at least one of: at least one first time offset, at least one second time offset, at least one frequency offset, a preamble, an index of a preamble from a set of predefined preambles, an at least one time resource, at least one frequency resource, centre frequency, a bandwidth, small frequency, sub band configuration, bit duration for transmission of at least one of bit 1 and bit 0 and time offset, a start time, an end time, a reference time, at least one periodicity, a time duration, a number of time units, a subcarrier spacing, a starting frequency resource, an ending frequency resource, a number of frequency resources, a carrier frequency,

identity of at least one bandwidth part, a slot index, a number of slots, a symbol index, a number of symbols, an amplification factor, a pattern to indicate the start of at least one of DL reception and UL transmission, an information about pattern to indicate the start of at least one of DL reception and UL transmission, a transmit power, number of CRC bits for generating a CRC polynomial, a ON-OFF pattern of at least one first node, a monitoring pattern to monitor a DL message, a clock to adjust the timing alignment between the at least one first node and a second node, and an information for transmitting at least one of DL reception and UL transmission. The monitoring pattern comprises at least one of: at least one periodicity, a time window, and at least one resource. The centre frequency is a middle frequency in a band of operation.

In an embodiment, the ON-OFF pattern indicates at least one of: time period for performing the at least one of DL reception and UL transmission by the at least one first node during the ON period, time period in which at least one first node is active during the ON period, time period for the sleep mode of at least one first node, time period for performing the energy harvesting by the at least one first node, time period in which at least one first node is not expected to perform at least one of DL reception and UL transmission during the OFF period and time period in which the at least one first node is in active.

In an embodiment, determining a first operation based on at least one of explicit indication, predefined and implicit indication, wherein the first operation is at least one of one of based on a data information and based on a control information, one of “inventory only” and “inventory and a second operation”, one of contention free procedure and contention based procedure and one of new procedure or re-access procedure, wherein the second operation is at least one of command, sensing and positioning.

In an embodiment, the implicit indication is based on a payload of at least one of a message and the first trigger message. An explicit indication is in at least one of the first trigger message, a activation message and a DL message.

In an embodiment, transmitting the third message with a third time offset is after one of receiving the one of the first trigger message, and the second message and transmitting the first message, wherein the third time offset is at least one of: received time offset explicitly, implicitly derived, determined based on at least one of the distances between the at least one first node and the second node and a minimum processing time of the at least one first node and predefined.

In an embodiment, the received time offset explicitly further comprises: at least one of: received in the first trigger message and the second message. A third time offset is one of: applied from one of the start of the first trigger message and the end of the first trigger message, applied from one of the start of the first message and the end of the first message and applied from one of the start of the second message and the end of the second message.

In an embodiment, transmitting the second scheduling request with a fourth time offset after one of receiving one of the first trigger message, the second message and the fourth message, and transmitting one of the first message and the third message, wherein the fourth time offset is at least one of: received time offset explicitly, implicitly derived, determined based on at least one of the distances between the at least one first node and the second node and a minimum processing time of the at least one first node and predefined. The received time offset explicitly further comprises: at least one of received in the first trigger message, the second message and the fourth message.

In an embodiment, the fourth time offset is one of: applied from one of the start of the first trigger message and the end of the first trigger message, applied from one of the start of the first message and the end of the first message, applied from one of the start of the second message and the end of the second message, applied from one of the start of the third message and the end of the third message, and applied from one of the start of the fourth message and the end of the fourth message. The fourth message is received with a fifth time offset after one of receiving one of first trigger message and the second message, and transmitting one of the first message and the third message, wherein the fifth time offset is at least one of: received time offset explicitly, implicitly derived, determined based on at least one of the distances between the at least one first node and the second node and a minimum processing time of the at least one first node and predefined. The received time offset explicitly further comprises: at least one of: received in the first trigger message and the second message.

In an embodiment, the fifth time offset is one of: applied from one of the start of the first trigger message and the end of the first trigger message, applied from one of the start of the first message and the end of the first message, applied from one of the start of the second message and the end of the second message, and applied from one of the start of the third message and the end of the third message. The second message is received with a sixth time offset after one of receiving the first trigger message and transmitting the first message, wherein the sixth time offset is at least one of: received time offset explicitly, implicitly derived, determined based on at least one of the distances between the at least one first node and the second node and a minimum processing time of the at least one first node and predefined.

In an embodiment, the received time offset explicitly further comprises: received in the first trigger message. The sixth time offset is one of: applied from one of the start of the first trigger message and the end of the first trigger message and applied from one of the start of the first message and the end of the first message. The at least one of the third time offset, the fourth time offset, fifth time offset, sixth time offset is equal. The at least one of the third time offset, the fourth time offset, fifth time offset, sixth time offset is defined as at least one of a symbol, a slot and a chip length.

In an embodiment, the second message is monitored in a first time window. The first time window is extended for monitoring the second message for a first time duration, declare process failure, counting a number of re transmission, re-transmission of the first message, and monitoring for a third trigger message, when one of receiving a negative acknowledgement in the second message, not receiving the second message, after the first time duration. The third trigger message comprises a re-access flag. The at least one of re transmission and monitoring is after the first time duration, wherein the first time duration is at least one of configured, predefined and implicitly derived.

In an embodiment, re-transmission of the first message in one of the at least one resource and at least one first resource, wherein re-transmission of the first message further comprises incrementing retransmit counter. The re-transmission of the first message is when the value in retransmit counter is less than a maximum number of retransmissions, wherein maximum number of retransmissions is at least one of a predefined value, received in the first trigger message.

In an embodiment, when a second trigger message is received, a response to the second trigger message may be skipped.

In an embodiment, trigger signal further comprises an identity, wherein the identity is at least one of ID of at least one second node, ID of a service type, ID of a at least first node and ID of a procedure. The response is skipped when one of: the second trigger message comprises an identity different from the identity present in the first trigger message, until receiving one of a fifth feedback and the fourth feedback sand a re-access flag is absent in the second trigger. The fifth feedback comprises one of a positive acknowledgement and negative acknowledgement, wherein the fourth message is monitored in a second time window.

In an embodiment, the second time window is extended for monitoring the fourth message for a second time duration, declare process failure, counting a number of re-transmission, re transmission of a UL message, and monitoring for a fourth trigger message, when one of receiving a negative acknowledgement in the fourth message, not receiving the fourth message, after the second time duration. The fourth trigger message comprises a re-access flag. The at least one of re transmission and monitoring is after the second time duration, wherein the second time duration is at least one of configured, predefined and implicitly derived. The transmission of a UL message is one of the first message and the third message, wherein re transmission in one of the at least one resource and at least one second resource. The re transmission further comprises incrementing retransmit counter, wherein re transmission is when the value in retransmit counter is less than a maximum number of retransmissions. The maximum number of retransmissions is at least one of a predefined value, received in the first trigger message and received in second message.

In an embodiment, performing at least one of, declare process failure, counting a number of re transmission, re transmission, and monitoring for a fifth trigger message when one of not receiving a carrier wave, not having enough energy for transmission, not completing the energy harvesting process, not in active on mode, one of transmission of the first message and the third message is not successful and in sleep mode. The fifth trigger message comprises a re-access flag. The re-transmission is at least one of first message and the third message. The re transmission is in one of the at least one resource and at least one third resource. The re transmission further comprises incrementing retransmit counter, wherein re transmission is when the value in retransmit counter is less than a maximum number of retransmissions. The maximum number of retransmissions is at least one of a predefined value, received in the first trigger message and received in second message.

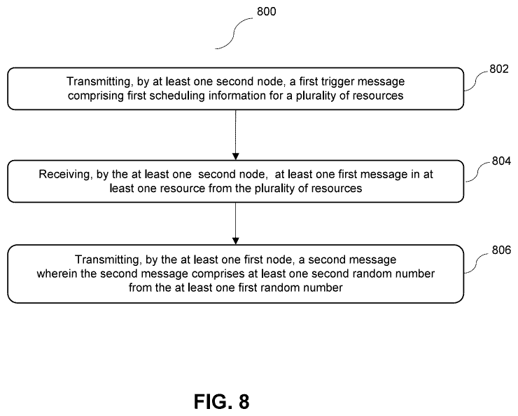

FIG. 8 illustrates a method 800 for establishing communication by a second node in accordance with an embodiment of the present disclosure, wherein the method comprises: transmitting 802, by at least one second node, a first trigger message comprising first scheduling information for a plurality of resources, wherein the first scheduling information comprises a first time offset indicating the start time of the plurality of resources and a second time offset indicating the start time of a resource from the plurality of resources, wherein the start time of the plurality of resources is the time obtained using the first time offset after the time instant of receiving one of the start of the first trigger message and the end of the first trigger message and wherein the start time of the resource from the plurality of resources is the time obtained using the second time offset after one of the time instant of receiving the start of the first trigger message the time instant of receiving the end of the first trigger message, and the start of the plurality of resources, receiving 804, by the at least one second node, at least one first message in at least one resource from the plurality of resources, wherein the at least one first message comprises at least one first random number. The first node transmits 806 a second message wherein the second message comprises at least one second random number from the at least one first random number.

In an embodiment, the at least one second node receives, at least one third message wherein the at least one third message comprises at least one of at least one third random number, identity of at least one first node, a third feedback, at least one capability of the at least one first node, a type of the at least one first node and a first scheduling request to transmit a third scheduling information. The at least one second node further transmits, a fourth message. The at least one of the first time offset and the second time offset is determined from a predefined set of time offsets. The one of transmission and reception of plurality of messages, are consecutive messages from the plurality of messages with a fixed time offset.

In an embodiment, the at least one first random number comprises at least one information about the at least one first node, wherein the at least one information comprises at least one bit in the identity of the at least one first node. The first trigger message transmitted further comprises transmitting a mapping function, wherein transmitting the mapping function is using at least one of RRC, MAC-CE and DCI. The mapping function is used for mapping a value to a resource from the plurality of resource, wherein the mapping the resources is one of counting the frequency domain resources followed by the time domain resources, and counting the time domain resources followed by frequency domain resources.

In an embodiment, the first trigger message further comprises at least one of an identity of at least one of at least one first node, at least one second node, type of the service, and process, a step size for the timer counter, a first integer value indicating range of value for generating a fourth random number, a second integer value indicating range of value for determining the step size for the timer counter, maximum value for this timer counter, maximum value for the step size, a third time offset, a time period for monitoring at least one of the second message and the fourth message, and at least one information to handle failure. The first time offset is the minimum time duration between a transmission and the subsequent reception. The second time offset is the minimum time duration between one of a transmission and the subsequent reception, and two consecutives receptions.

In an embodiment, the at least one first message further comprises at least one of at least one preamble, at least one first feedback and at least one identity of the at least one first node, wherein the at least one feedback is in response to transmission of the first trigger message. The at least one first feedback message is one of positive acknowledgment and negative acknowledgement. The at least one first feedback message comprises an ACK when the transmission of the first trigger message is successful and a NACK when the transmission of the first trigger is unsuccessful, wherein transmitting the first trigger message further comprises transmitting at least one preamble. The transmission of the first trigger message is in the at least one resource.

In an embodiment, the second message further comprises at least one of: at least one second scheduling information for a third message, at least one second feedback message, at least one identity of the at least one first node and at least one preamble. The at least second feedback message is in response to reception of the first message, wherein the at least one second feedback message is one of positive acknowledgment and negative acknowledgement. The at least one second feedback message is an ACK when the reception of the first message is successful and a NACK when the reception of the first message is unsuccessful. The at least one third message is received in the at least one resource, wherein receiving the at least one third message is in the at least one resource, when the at least one second scheduling information for the at least one third message is absent in the at least one second message.

In an embodiment, the fourth message comprises at least one of: at least one identity of the at least one first node, an acknowledgement, and an fourth scheduling information for at least one of DL reception and UL transmission. The Acknowledgement comprises an ACK when reception of the third message is successful and a NACK when the reception of the third message is unsuccessful. The one of transmitting the first trigger message and transmitting the second message further comprises transmitting at least one of a first pattern and a second pattern, wherein the first pattern indicate the start of at least one of DL operation and UL operation. The second pattern indicates at least one of the bit duration, information about clock signal and synchronization information.

In an embodiment, an ON-OFF pattern is transmitted to indicate the time at which the device receives and transmits the messages during the RACH process.

In an embodiment, one of the first scheduling information, the third scheduling information the second scheduling information, the fourth scheduling comprises at least one of: at least one first time offset, at least one second time offset, at least one time offset, at least one frequency offset, a preamble, an index of a preamble from a set of predefined preambles, an at least one time resource, at least one frequency resource, centre frequency, a bandwidth, small frequency, sub band configuration, bit duration of at least one of bit 1 and bit 0 and time offset, a start time, an end time, a reference time, at least one periodicity, a time duration, a number of time units, a subcarrier spacing, a starting frequency resource, an ending frequency resource, a number of frequency resources, a carrier frequency, identity of at least one bandwidth part, a slot index, a number of slots, a symbol index, a number of symbols, an amplification factor, a pattern to indicate the start of at least one of DL reception and UL transmission, an information about pattern to indicate the start of at least one of DL reception and UL transmission, a transmit power, number of CRC bits for generating a CRC polynomial, a ON-OFF pattern of at least one first node, a monitoring pattern to monitor a DL message, and a clock to indicate the timing associated with the at least one second node.

In an embodiment, the monitoring pattern comprises at least one of: at least one periodicity, a time window and at least one resource. The centre frequency is a middle frequency in a band of operation.

In an embodiment, the ON-OFF pattern indicates at least one of: time period for performing the at least one of DL reception and UL transmission by the at least one first node during the ON period, time period in which at least one first node is active during the ON period, time period for the sleep mode of at least one first node, time period for performing the energy harvesting by the at least one first node, time period in which at least one first node is not expected to perform at least one of DL reception and UL transmission during the OFF period and time period in which the at least one first node is in active.

In an embodiment, a second scheduling request is also received. The second message is transmitted with a third time offset after one of Time instant of transmitting the first trigger message, Time instant of receiving the first message, the start time of the plurality of resources and end time of the plurality of resources.

In an embodiment, the third time offset is one of: applied from one of the start of the first trigger message and the end of the first trigger message, applied from one of the start of the first message and the end of the first message, applied from the start of plurality of resources, and applied from the end time of the plurality of resources. The third message is received with a fourth time offset after one of: Time instant of transmitting the first trigger message, Time instant of receiving the first message, Time instant of transmitting the second message, the start time of the plurality of resources and end time of the plurality of resources.

In an embodiment, the fourth time offset is one of: applied from one of the start of the first trigger message and the end of the first trigger message, applied from one of the start of the first message and the end of the first message, applied from one of the start of the second message and the end of the second message, applied from the start of plurality of resources, and applied from the end time of the plurality of resources. The fourth message is transmitted with a fifth time offset after one of: Time instant of transmitting the first trigger message, Time instant of receiving the first message, Time instant of transmitting the second message, Time instant of receiving the third message, the start time of the plurality of resources and end time of the plurality of resources.

In an embodiment, the fifth time offset is one of: applied from one of the start of the first trigger message and the end of the first trigger message, applied from one of the start of the first message and the end of the first message, applied from one of the start of the second message and the end of the second message, applied from one of the start of the third message and the end of the third message, applied from the start of plurality of resources, and applied from the end time of the plurality of resources.

In an embodiment, a scheduling request with a sixth time offset is received after one of: Time instant of transmitting the first trigger message, Time instant of receiving the first message, Time instant of transmitting the second message, Time instant of receiving the third message, Time instant of transmitting the fourth message, the start time of the plurality of resources, and end time of the plurality of resources. The sixth time offset is one of: applied from one of the start of the first trigger message and the end of the first trigger message, applied from one of the start of the first message and the end of the first message, applied from one of the start of the second message and the end of the second message, applied from one of the start of the third message and the end of the third message, applied from one of the start of the fourth message and the end of the fourth message, applied from the start of plurality of resources, and applied from the end time of the plurality of resources.

In an embodiment, the at least one of the third time offset, the fourth time offset, fifth time offset, the sixth time offset is equal. The at least one of the third time offset, the fourth time offset, fifth time offset, the sixth time offset is defined as at least one of a symbol, a slot and a chip length.

In an embodiment, the information to handle RACH failure comprises at least one of: Condition to declare process failure, scheduling information for retransmission of the at least one first message maximum number of re-transmissions allowed for the at least one first message, scheduling information for retransmission of the at least one third message, maximum number of re-transmissions allowed for the at least one third message, offset to extend the time period for monitoring the second message and offset to extend the time period for monitoring the fourth message.

In an embodiment, transmitting the first trigger message is periodic. A second trigger message is transmitted, wherein the second trigger message comprises one of a re access flag and a identity different from the identity in the first trigger signal. Transmitting the first trigger message further comprises skipping transmission of a second trigger message. The second trigger message comprises the identity.

In an embodiment, configuring the at least one first node to select a two-step RACH procedure and a four step RACH procedure is based on at least one of energy storage of the at least one first node, a service type, at least one first node capability, a new identified at least one first node, and the initial transmission procedure or retransmission procedure. The service type is at least one of inventory, sensor, positioning and command.

In an embodiment, the at least one first node is identified by a two-step RACH or a four step RACH.

In an embodiment, an apparatus for establishing communication with a device in cellular communications comprises a processor, a memory storing program instructions which, when executed by the processor, causes the processor to receive, a first trigger message, wherein the first trigger message comprises a first scheduling information for transmission. The processor determines, plurality of resources configured for transmission, wherein determining comprises, determining a start time of a resource from the plurality of resources based on the first trigger message and using at least one time offset.

In an embodiment, the start time is one of: the time obtained using the at least one time offset after the time instant of receiving one of the start of the first trigger message and the end of the first trigger message and sum of the at least one time offset after the time instant of receiving one of the start of the first trigger message and end of the first trigger message. The processor transmits a first message in at least one resource from the plurality of resources, wherein the first message comprises a first random number. The processor receives a second message, wherein the second message comprises at least one second random number. A third message is transmitted if the at least one second random number contains the first random number. A first trigger message is received, wherein the first trigger message comprises a first scheduling information for transmission. The processor determines plurality of resources for transmission, wherein determining comprises, determining a start time of a resource from the plurality of resources based on the first trigger message and using at least one time offset.

In an embodiment, the start time is one of: the time obtained using the at least one time offset after the time instant of receiving one of the start of the first trigger message and the end of the first trigger message and sum of the at least one time offset after the time instant of receiving one of the start of the first trigger message and end of the first trigger message. A first message is transmitted in at least one resource from the plurality of resources, wherein the first message comprises a first random number. A second message is received, wherein the second message comprises at least one second random number. A third message is transmitted, if the at least one second random number contains the first random number.

In an embodiment, an apparatus for establishing communication with a device in cellular communications comprises a processor, a memory storing program instructions which, when executed by the processor, causes the processor to transmit, a first trigger message comprising first scheduling information for a plurality of resources, wherein the first scheduling information comprises a first time offset indicating the start time of the plurality of resources and a second time offset indicating the start time of a resource from the plurality of resources, wherein the start time of the plurality of resources is the time obtained using the first time offset after the time instant of receiving one of the start of the first trigger message and the end of the first trigger message and wherein the start time of the resource from the plurality of resources is the time obtained using the second time offset after one of the time instant of receiving the start of the first trigger message, the time instant of receiving the end of the first trigger message, and the start of the plurality of resources, receive at least one first message in at least one resource from the plurality of resources, wherein the at least one first message comprises at least one first random number, transmit, a second message wherein the second message comprises at least one second random number from the at least one first random number.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

We claim:

1. A method for establishing communication with a device in cellular communication, comprising:
receiving, by at least one first node, a first trigger message,
wherein the first trigger message comprises a first scheduling information for transmission;
determining, by the at least one first node, plurality of resources configured for transmission;
wherein determining comprises, determining a start time of a resource from the plurality of resources based on the first trigger message and using at least one time offset;
wherein the start time is one of:
the time obtained using the at least one time offset after the time instant of receiving one of the start of the first trigger message and the end of the first trigger message and,
sum of the at least one time offset after the time instant of receiving one of the start of the first trigger message and end of the first trigger message
transmitting, by the at least one first node, a first message in at least one resource from the plurality of resources, wherein the first message comprises a first random number
receiving, by the at least one first node, a second message;
wherein the second message comprises at least one second random number
transmitting, by the at least one first node, a third message, if the at least one second random number contains the first random number.

2. The method as claimed in claim 1, wherein the at least one of the at least one time offset
is at least one of received time offset explicitly, implicitly derived using another received time offset and predefined.

3. The method as claimed in claim 1, wherein further comprising: one of transmission and reception of plurality of messages, wherein consecutive messages from the plurality of messages are one of transmitted and received with a fixed time offset.

4. The method as claimed in claim 1, wherein the first random number is generated based on the first trigger message.

5. The method as claimed in claim 1, comprises determining the at least one resource:
wherein determining the at least one resource comprising:
generating a third random number,
assigning the third random number to a timer counter;
one of decrementing and incrementing the timer counter and
determining the at least one resource from the plurality of resources at the expiry of the timer counter.

6. The method as claimed in claim 5, wherein generating the third random number is based on one of:
the first trigger message; and
at least one bit in the identity of the at least one first node.

7. The method as claimed in claim 5, wherein determining the at least one resource comprises mapping the value of the timer counter as the at least one resource.

8. The method as claimed in claim 7, wherein the mapping is one of predefined and signalled using at least one of RRC, MAC-CE and DCI.

9. The method as claimed in claim 7, wherein the mapping the resources is one of counting the
frequency domain resources followed by the time domain resources, and
counting the time domain resources followed by frequency domain resources.

10. The method as claimed in claim 5, wherein one of decrementing and incrementing the timer counter is based on a step size.

11. The method as claimed in claim 1, wherein the first trigger signal further comprises:
at least one information to generate the third random number,
wherein the at least one information to generate the third random number comprises at least one of a first integer value and a second integer value.

12. The method as claimed in claim 11, wherein the first integer value is used for generating at least one of length of the third random number and a range for selecting the third random number.

13. The method as claimed in claim 11, wherein the second integer value is used for generating a range for selecting a step size.

14. The method as claimed in claim 1, comprises determining the at least one resource is based on an identity of the at least one first node.

15. The method as claimed in claim 14, wherein the identity is one of a decimal value and plurality of the bits.

16. The method as claimed in claim 15, wherein at least one bit in the identity maps to the at least one resource.

17. The method as claimed in claim 1, wherein the time offset in the at least one time offset is at least one of predefined, explicitly indicated in the first trigger message and implicitly derived.

18. The method as claimed in claim 1, wherein the at least one time offset is the minimum time duration between at least one of:
a reception and the subsequent transmission; and
two consecutives transmissions.

19. The method as claimed in claim 1, wherein the first message further comprises at least one of a preamble, a first feedback message and identity of the at least one first node.

20. The method as claimed in claim 19, wherein the first feedback message is in response to reception of the first trigger message.

21. The method as claimed in claim 19, wherein the first feedback message is one of positive acknowledgment and negative acknowledgement.

22. The method as claimed in claim 19, wherein the first feedback message comprises an ACK when the reception of the first trigger message is successful and a NACK when the reception of the first trigger is unsuccessful.

23. The method as claimed in claim 19, wherein the preamble is from plurality of preamble received in the first trigger message.

24. The method as claimed in claim 1, wherein transmitting the first message is in at least one resource in which the first trigger message is received.

25. The method as claimed in claim 1, wherein the second message further comprises at least one of:
a second scheduling information for the third message;
a second feedback message;
identity of the at least one first node; and
at least one preamble.

26. The method as claimed in claim 25, wherein the second feedback message is in response to transmission of the first message.

27. The method as claimed in claim 25, wherein the second feedback message is one of positive acknowledgment and negative acknowledgement.

28. The method as claimed in claim 25, wherein the second feedback message comprises an ACK when the transmission of the first message is successful and a NACK when the transmission of the first message is unsuccessful.

29. The method as claimed in claim 1, wherein transmitting the third message is in the at least one resource.

30. The method as claimed in claim 29, wherein transmitting the third message is in the at least one resource, when the second scheduling information for the third message is absent in the second message.

31. The method as claimed in claim 1, wherein the third message comprises at least one of: identity of the at least one first node, at least one capability of the at least one first node, a third feedback message, a type of the at least one first node and a first scheduling request to transmit a third scheduling information for at least one of DL reception and UL transmission.

32. The method as claimed in claim 31, wherein the third feedback message is in response to reception of second message.

33. The method as claimed in claim 31, wherein the third feedback message is one of positive acknowledgment and negative acknowledgement.

34. The method as claimed in claim 31, wherein the third feedback message comprises an ACK when the reception of the second message is successful and a NACK when the reception of the second message is unsuccessful.

35. The method as claimed in claim 1, further comprises receiving, by the at least one first node, a fourth message.

36. The method as claimed in claim 35, wherein the fourth message comprises at least one of:
identity of the at least one first node, a fourth feedback message, and an fourth scheduling information for at least one of DL reception and UL transmission.

37. The method as claimed in claim 36, wherein the fourth feedback message is in response to transmission of the third message.

38. The method as claimed in claim 36, wherein the fourth feedback message is one of positive acknowledgment and negative acknowledgement.

39. The method as claimed in claim 36, wherein the fourth feedback comprises an ACK when transmission of the third message is successful and a NACK when the transmission of the third message is unsuccessful.

40. The method as claimed in claim 1, wherein receiving further comprises receiving at least one of:
a first pattern to indicate the start of at least one of DL reception and UL transmission;
a clock to adjust the timing alignment between the at least one first node and the second node; and
a second pattern to indicate the bit duration.

41. The method as claimed in claim 1, further comprises receiving an ON-OFF pattern.

42. The method as claimed in claim 1, wherein obtaining the time further comprising:
determining start of the plurality of resources by applying at least one first time offset after the time instant of receiving one of the start of the first trigger message and end of the first trigger message; and
determining a resource from plurality of resources by applying at least one second time offset after the time instant of the start of the plurality of resources.

43. The method as claimed in claim 42, wherein at least one of the at least one first time offset and the at least one second time offset is at least one of received time offset explicitly, implicitly derived and predefined.

44. The method as claimed in claim 1, further comprising transmitting, a second scheduling request to transmit a fifth scheduling information.

45. The method as claimed in at least one of claim 1, claim 25, claim 31, claim 36 and claim 44, wherein one of the first scheduling information, the second scheduling information, the third scheduling information, the fourth scheduling information and fifth scheduling comprises at least one of:
at least one first time offset,
at least one second time offset,
at least one frequency offset,
a preamble,
an index of a preamble from a set of predefined preambles,
an at least one time resource
at least one frequency resource;
centre frequency,
a bandwidth,
small frequency,
sub band configuration,
bit duration for transmission of at least one of bit 1 and bit 0 and time offset,
a start time,
an end time,
a reference time,
at least one periodicity,
a time duration,
a number of time units,
a subcarrier spacing,
a starting frequency resource,
an ending frequency resource,
a number of frequency resources,
a carrier frequency,
identity of at least one bandwidth part,
a slot index,
a number of slots,
a symbol index,
a number of symbols,
an amplification factor,
a pattern to indicate the start of at least one of DL reception and UL transmission,
an information about pattern to indicate the start of at least one of DL reception and UL transmission,
a transmit power,
number of CRC bits for generating a CRC polynomial,
a ON-OFF pattern of at least one first node,
a monitoring pattern to monitor a DL message,
a clock to adjust the timing alignment between the at least one first node and a second node, and
an information for transmitting at least one of DL reception and UL transmission.

46. The method as claimed in claim 45, wherein the monitoring pattern comprises at least one of:
at least one periodicity,
a time window, and
at least one resource.

47. The method as claimed in claim 45, wherein, the centre frequency is a middle frequency in a band of operation.

48. The method as claimed in at least one of claim 41 and claim 45, wherein the ON-OFF pattern indicates at least one of:
time period for performing the at least one of DL reception and UL transmission by the at least one first node during the ON period;
time period in which at least one first node is active during the ON period;
time period for the sleep mode of at least one first node;
time period for performing the energy harvesting by the at least one first node;
time period in which at least one first node is not expected to perform at least one of DL reception and UL transmission during the OFF period; and
time period in which the at least one first node is in active.

49. The method as claimed in claim 1, further comprises determining a first operation based on at least one of explicit indication, predefined and implicit indication.

50. The method as claimed in claim 49, wherein the first operation is at least one of:
one of based on a data information and based on a control information,
one of “inventory only” and “inventory and a second operation”
one of contention free procedure and contention based procedure,
one of new procedure or re-access procedure.

51. The method as claimed in claim 50, wherein the second operation is at least one of command, sensing and positioning.

52. The method as claimed in claim 49, wherein the implicit indication is based on a payload of at least one of a message and the first trigger message.

53. The method as claimed in claim 49, wherein the explicit indication is in at least one of the first trigger message, an activation message and a DL message.

54. The method as claimed in claim 1, further comprising:
transmitting the third message with a third time offset after one of
receiving the one of the first trigger message, and the second message, and
transmitting the first message.

55. The method as claimed in claim 54, wherein the third time offset is at least one of:
received time offset explicitly,
implicitly derived,
determined based on at least one of the distances between the at least one first node and the second node and a minimum processing time of the at least one first node and predefined.

56. The method as claimed in claim 55, wherein received time offset explicitly further comprises:
at least one of:
received in the first trigger message and the second message.

57. The method as claimed in claim 54, wherein the third time offset is one of:
applied from one of the start of the first trigger message and the end of the first trigger message,
applied from one of the start of the first message and the end of the first message, and
applied from one of the start of the second message and the end of the second message.

58. The method as claimed in claim 44, further comprising:
transmitting the second scheduling request with a fourth time offset after one of receiving one of the first trigger message, the second message and the fourth message, and
transmitting one of the first message and the third message.

59. The method as claimed in claim 58, wherein the fourth time offset is at least one of:
received time offset explicitly,
implicitly derived,
determined based on at least one of the distances between the at least one first node and the second node and a minimum processing time of the at least one first node and predefined.

60. The method as claimed in claim 59, wherein received time offset explicitly further comprises: at least one of received in the first trigger message, the second message and the fourth message.

61. The method as claimed in claim 58, wherein the fourth time offset is one of:
applied from one of the start of the first trigger message and the end of the first trigger message,
applied from one of the start of the first message and the end of the first message, applied from one of the start of the second message and the end of the second message,
applied from one of the start of the third message and the end of the third message, and applied from one of the start of the fourth message and the end of the fourth message.

62. The method as claimed in claim 35, further comprising:
receiving the fourth message with a fifth time offset after one of
receiving one of first trigger message and the second message, and
transmitting one of the first message and the third message.

63. The method as claimed in claim 62, wherein the fifth time offset is at least one of:
received time offset explicitly,
implicitly derived,
determined based on at least one of the distances between the at least one first node and the second node and a minimum processing time of the at least one first node and predefined.

64. The method as claimed in claim 63, wherein received time offset explicitly further comprises:
at least one of
received in the first trigger message and the second message.

65. The method as claimed in claim 62, wherein the fifth time offset is one of:
applied from one of the start of the first trigger message and the end of the first trigger message,
applied from one of the start of the first message and the end of the first message, applied from one of the start of the second message and the end of the second message, and
applied from one of the start of the third message and the end of the third message.

66. The method as claimed in claim 1, further comprising:
receiving the second message with a sixth time offset after one of
receiving the first trigger message and
transmitting the first message.

67. The method as claimed in claim 66, wherein the sixth time offset is at least one of:
received time offset explicitly,
implicitly derived,
determined based on at least one of the distances between the at least one first node and the second node and a minimum processing time of the at least one first node and predefined.

68. The method as claimed in claim 67, wherein received time offset explicitly further comprises: received in the first trigger message.

69. The method as claimed in claim 66, wherein the sixth time offset is one of:
applied from one of the start of the first trigger message and the end of the first trigger message; and
applied from one of the start of the first message and the end of the first message,

70. The method as claimed in at least one of claim 54, claim 58, claim 62, and claim 66, wherein at least one of the third time offset, the fourth time offset, fifth time offset, sixth time offset is equal.

71. The method as claimed in at least one of claim 54, claim 58, claim 62, and claim 66, wherein at least one of the third time offset, the fourth time offset, fifth time offset, sixth time offset is defined as at least one of a symbol, a slot and a chip length.

72. The method as claimed in claim 1, wherein the second message is monitored in a first time window.

73. The method as claimed in at least one of claim 1 and 72, further comprising performing at least one of:
extending the first time window for monitoring the second message for a first time duration,
declare process failure,
counting a number of re transmission,
re transmission of the first message, and
monitoring for a third trigger message,
when one of
receiving a negative acknowledgement in the second message,
not receiving the second message,
after the first time duration.

74. The method as claimed in 73, wherein the third trigger message comprises a re-access flag.

75. The method as claimed in claim 73, wherein at least one of re transmission and monitoring is after the first time duration.

76. The method as claimed in claim 73, wherein the first time duration is at least one of configured, predefined and implicitly derived.

77. The method as claimed in claim 73, wherein re transmission of the first message in one of the at least one resource and at least one first resource.

78. The method as claimed in claim 73, wherein re transmission of the first message further comprises incrementing retransmit counter.

79. The method as claimed in claim 73, wherein re transmission of the first message is when the value in retransmit counter is less than a maximum number of retransmissions.

80. The method as claimed in claim 79, wherein maximum number of retransmissions is at least one of a predefined value, received in the first trigger message.

81. The method as claimed in claim 1, further comprises receiving a second trigger message.

82. The method as claimed in claim 81, wherein a response to the second trigger message is skipped.

83. The method as claimed in claim 1, wherein trigger signal further comprises an identity.

84. The method as claimed in claim 83, wherein the identity is at least one of ID of at least one second node, ID of a service type, ID of a at least first node and ID of a procedure.

85. The method as claimed in at least one of claim 82 and claim 83, wherein the response is skipped when one of:
the second trigger message comprises an identity different from the identity present in the first trigger message;
until receiving one of a fifth feedback and the fourth feedback;
a timer expires; and
a re-access flag is absent in the second trigger.

86. The method as claimed in claim 85, wherein the fifth feedback comprises one of a positive acknowledgement and negative acknowledgement.

87. The method as claimed in claim 35, wherein the fourth message is monitored in a second time window.

88. The method as claimed in at last one of claim 1 and claim 87, further comprising performing at least one of:
extending the second time window for monitoring the fourth message for a second time duration,
declare process failure,
counting a number of re transmission,
re transmission of a UL message, and
monitoring for a fourth trigger message.
when one of
receiving a negative acknowledgement in the fourth message,
not receiving the fourth message,
after the second time duration.

89. The method as claimed in claim 88, wherein the fourth trigger message comprises a re-access flag.

90. The method as claimed in claim 88, wherein at least one of re transmission and monitoring is after the second time duration.

91. The method as claimed in claim 90, wherein the second time duration is at least one of configured, predefined and implicitly derived.

92. The method as claimed in claim 88, wherein re transmission of a UL message is one of the first message and the third message.

93. The method as claimed in claim 88, wherein re transmission in one of the at least one resource and at least one second resource.

94. The method as claimed in claim 88, wherein re transmission further comprises incrementing retransmit counter.

95. The method as claimed in claim 88, wherein re transmission is when the value in retransmit counter is less than a maximum number of retransmissions.

96. The method as claimed in claim 95, wherein maximum number of retransmissions is at least one of a predefined value, received in the first trigger message and received in second message.

97. The method as claimed in claim 1, further comprises performing at least one of,
declare process failure,
counting a number of re transmission,
re transmission, and
monitoring for a fifth trigger message
when one of
not receiving a carrier wave,
not having enough energy for transmission,
not completing the energy harvesting process,
not in active on mode,
one of transmission of the first message and the third message is not successful and in sleep mode.

98. The method as claimed in claim 97, wherein the fifth trigger message comprises a re-access flag.

99. The method as claimed in claim 97, wherein re transmission is at least one of first message and the third message.

100. The method as claimed in claim 97, wherein re transmission in one of the at least one resource and at least one third resource.

101. The method as claimed in claim 97, wherein re transmission further comprises incrementing retransmit counter.

102. The method as claimed in claim 97, wherein re transmission is when the value in retransmit counter is less than a maximum number of retransmissions.

103. The method as claimed in claim 102, wherein maximum number of retransmissions is at least one of a predefined value, received in the first trigger message and received in second message.

104. A method for establishing communication with a device in cellular communication, comprising:
transmitting, by at least one second node, a first trigger message comprising first scheduling information for a plurality of resources,
wherein the first scheduling information comprises a first time offset indicating the start time of the plurality of resources and a second time offset indicating the start time of a resource from the plurality of resources,
wherein the start time of the plurality of resources is the time obtained using the first time offset after the time instant of receiving one of the start of the first trigger message and the end of the first trigger message, and,
wherein the start time of the resource from the plurality of resources is the time obtained using the second time offset after one of
the time instant of receiving the start of the first trigger message
the time instant of receiving the end of the first trigger message, and
the start of the plurality of resources
receiving, by the at least one second node, at least one first message in at least one resource from the plurality of resources;
wherein the at least one first message comprises at least one first random number
transmitting, by the at least one first node, a second message
wherein the second message comprises at least one second random number from the at least one first random number.

105. The method as claimed in claim 104, further comprises
receiving, by the at least one second node, at least one third message
wherein the at least one third message comprises at least one of
at least one third random number,
identity of at least one first node.
a third feedback,
at least one capability of the at least one first node,
a type of the at least one first node, and
a first scheduling request to transmit a third scheduling information.

106. The method as claimed in claim 104, further comprises transmitting, by the at least one second node, a fourth message.

107. The method as claimed in claim 104, wherein at least one of the first time offset and the second time offset is determined from a predefined set of time offsets.

108. The method as claimed in claim 104, wherein further comprising: one of transmission and reception of plurality of messages, wherein consecutive messages from the plurality of messages are one of transmitted and received with a fixed time offset.

109. The method as claimed in claim 104, wherein the at least one first random number comprises at least one information about the at least one first node
wherein the at least one information comprises at least one bit in the identity of the at least one first node.

110. The method as claimed in claim 104, wherein transmitting the first trigger message further comprises transmitting a mapping function.

111. The method as claimed in claim 110, wherein transmitting the mapping function is using at least one of RRC, MAC-CE and DCI.

112. The method as claimed in claim 110, wherein the mapping function is used for mapping a value to a resource from the plurality of resource.

113. The method as claimed in claim 112, wherein the mapping the resources is one of counting the frequency domain resources followed by the time domain resources, and counting the time domain resources followed by frequency domain resources.

114. The method as claimed in at least one of claim 104 and claim 106, wherein the first trigger message further comprises at least one of
an identity of at least one of at least one first node, at least one second node, type of the service, and process,
a step size for the timer counter,
a first integer value indicating range of value for generating a fourth random number
a second integer value indicating range of value for determining the step size for the timer counter,
maximum value for this timer counter,
maximum value for the step size,
a third time offset,
a time period for monitoring at least one of the second message and the fourth message, and
at least one information to handle failure.

115. The method as claimed in claim 104, wherein the first time offset is the minimum time duration between a transmission and the subsequent reception.

116. The method as claimed in claim 104, wherein the second time offset is the minimum time duration between one of
a transmission and the subsequent reception, and
two consecutives receptions.

117. The method as claimed in claim 104, wherein the at least one first message further comprises at least one of
at least one preamble,
at least one first feedback and
at least one identity of the at least one first node.

118. The method as claimed in claim 117, wherein the at least one feedback is in response to transmission of the first trigger message.

119. The method as claimed in claim 117, wherein the at least one first feedback message is one of positive acknowledgment and negative acknowledgement.

120. The method as claimed in claim 117, wherein the at least one first feedback message comprises an ACK when the transmission of the first trigger message is successful and a NACK when the transmission of the first trigger is unsuccessful.

121. The method as claimed in claim 104, wherein transmitting the first trigger message further comprises transmitting at least one preamble.

122. The method as claimed in claim 104, wherein transmitting the first trigger message is in the at least one resource.

123. The method as claimed in claim 104, wherein the second message further comprises at least one of:
At least one second scheduling information for a third message;
At least one second feedback message;
At least one identity of the at least one first node;
and at least one preamble.

124. The method as claimed in claim 123, wherein the at least second feedback message is in response to reception of the first message.

125. The method as claimed in claim 123, wherein the at least one second feedback message is one of positive acknowledgment and negative acknowledgement.

126. The method as claimed in claim 123, wherein the at least one second feedback message is an ACK when the reception of the first message is successful and a NACK when the reception of the first message is unsuccessful.

127. The method as claimed in claim 123, wherein receiving the at least one third message is in the at least one resource.

128. The method as claimed in claim 127, wherein receiving the at least one third message is in the at least one resource, when the at least one second scheduling information for the at least one third message is absent in the at least one second message.

129. The method as claimed in claim 106, wherein the fourth message comprises at least one of:
at least one identity of the at least one first node,
an acknowledgement, and
an fourth scheduling information for at least one of DL reception and UL transmission.

130. The method as claimed in claim 129, wherein the Acknowledgement comprises an ACK when reception of the third message is successful and a NACK when the reception of the third message is unsuccessful.

131. The method as claimed in claim 104, wherein one of transmitting the first trigger message and transmitting the second message further comprises transmitting at least one of a first pattern and a second pattern
wherein the first pattern indicate the start of at least one of DL operation and UL operation,
wherein the second pattern indicate at least one of the bit duration, information about clock signal and synchronization information.

132. The method as claimed in claim 104, further comprises transmitting an ON-OFF pattern.

133. The method as claimed in at least one of claim 104, claim 105, claim 123 and claim 129, wherein one of the first scheduling information, the third scheduling information the second scheduling information, the fourth scheduling comprises at least one of:
at least one first time offset,
at least one second time offset,
at least one time offset,
at least one frequency offset,
a preamble,
an index of a preamble from a set of predefined preambles,
an at least one time resource
at least one frequency resource;
centre frequency,
a bandwidth,
small frequency,
sub band configuration,
bit duration of at least one of bit 1 and bit 0 and time offset,
a start time,
an end time,
a reference time,
at least one periodicity,
a time duration,
a number of time units,
a subcarrier spacing,
a starting frequency resource,
an ending frequency resource,
a number of frequency resources,
a carrier frequency,
identity of at least one bandwidth part,
a slot index,
a number of slots,
a symbol index,
a number of symbols,
an amplification factor,
a pattern to indicate the start of at least one of DL reception and UL transmission,
an information about pattern to indicate the start of at least one of DL reception and UL transmission,
a transmit power,
number of CRC bits for generating a CRC polynomial,
a ON-OFF pattern of at least one first node,
a monitoring pattern to monitor a DL message, and
a clock to indicate the timing associated with the at least one second node.

134. The method as claimed in claim 95, wherein the monitoring pattern comprises at least one of:
at least one periodicity,
a time window, and
at least one resource.

135. The method as claimed in claim 133, wherein, the centre frequency is a middle frequency in a band of operation.

136. The method as claimed in at least one of claim 132 and claim 133, wherein the ON-OFF pattern indicates at least one of:
time period for performing the at least one of DL reception and UL transmission by the at least one first node during the ON period;
time period in which at least one first node is active during the ON period;
time period for the sleep mode of at least one first node;
time period for performing the energy harvesting by the at least one first node;
time period in which at least one first node is not expected to perform at least one of DL reception and UL transmission during the OFF period; and
time period in which the at least one first node is in active.

137. The method as claimed in claim 104, further comprising receiving a second scheduling request.

138. The method as claimed in claim 104, wherein transmitting the second message with a third time offset after one of
Time instant of transmitting the first trigger message,
Time instant of receiving the first message
the start time of the plurality of resources
end time of the plurality of resources.

139. The method as claimed in claim 138, wherein the third time offset is one of:
applied from one of the start of the first trigger message and the end of the first trigger message,
applied from one of the start of the first message and the end of the first message,
applied from the start of plurality of resources, and
applied from the end time of the plurality of resources.

140. The method as claimed in claim 105, wherein receiving the third message with a fourth time offset after one of
Time instant of transmitting the first trigger message,
Time instant of receiving the first message
Time instant of transmitting the second message
the start time of the plurality of resources, and
end time of the plurality of resources.

141. The method as claimed in claim 140, wherein the fourth time offset is one of:
applied from one of the start of the first trigger message and the end of the first trigger message,
applied from one of the start of the first message and the end of the first message,
applied from one of the start of the second message and the end of the second message,
applied from the start of plurality of resources, and
applied from the end time of the plurality of resources.

142. The method as claimed in claim 106, wherein transmitting the fourth message with a fifth time offset after one of
Time instant of transmitting the first trigger message,
Time instant of receiving the first message
Time instant of transmitting the second message
Time instant of receiving the third message
the start time of the plurality of resources, and
end time of the plurality of resources.

143. The method as claimed in claim 142, wherein the fifth time offset is one of:
applied from one of the start of the first trigger message and the end of the first trigger message,
applied from one of the start of the first message and the end of the first message,
applied from one of the start of the second message and the end of the second message,
applied from one of the start of the third message and the end of the third message,
applied from the start of plurality of resources, and
applied from the end time of the plurality of resources.

144. The method as claimed in claim 137, wherein receiving the scheduling request with a sixth time offset after one of
Time instant of transmitting the first trigger message,
Time instant of receiving the first message
Time instant of transmitting the second message
Time instant of receiving the third message
Time instant of transmitting the fourth message
the start time of the plurality of resources, and
end time of the plurality of resources.

145. The method as claimed in claim 144, wherein the sixth time offset is one of:
applied from one of the start of the first trigger message and the end of the first trigger message,
applied from one of the start of the first message and the end of the first message, applied from one of the start of the second message and the end of the second message,
applied from one of the start of the third message and the end of the third message, applied from one of the start of the fourth message and the end of the fourth message, applied from the start of plurality of resources, and
applied from the end time of the plurality of resources.

146. The method as claimed in at least one of claim 138, claim 140, claim 142, claim 144, wherein at least one of the third time offset, the fourth time offset, fifth time offset, the sixth time offset is equal.

147. The method as claimed in at least one of claim 138, claim 140, claim 142, claim 144, wherein at least one of the third time offset, the fourth time offset, fifth time offset, the sixth time offset is defined as at least one of a symbol, a slot and a chip length.

148. The method as claimed in at least one of claim 105 and claim 114, wherein at least one information to handle failure comprises at least one of
Condition to declare process failure,
scheduling information for retransmission of the at least one first message maximum number of re-transmissions allowed for the at least one first message,
scheduling information for retransmission of the at least one third message maximum number of re-transmissions allowed for the at least one third message,
offset to extend the time period for monitoring the second message and offset to extend the time period for monitoring the fourth message.

149. The method as claimed in claim 104, wherein transmitting the first trigger message is periodic.

150. The method as claimed in claim 104, further comprises transmitting a second trigger message.

151. The Method as claimed in at least one of claim 114 and claim 150, wherein the second trigger message comprises one of a re access flag and a identity different from the identity in the first trigger signal.

152. The method as claimed in claim 104, wherein transmitting a first trigger message further comprises skipping transmission of a second trigger message.

153. The method as claimed in claim 114 and claim 152, wherein the second trigger message comprises the identity.

154. The method as claimed in claim 104, comprising: configuring the at least one first node to select a two-step RACH procedure and a four step RACH procedure based on at least one of energy storage of the at least one first node, a service type, at least one first node capability, a new identified at least one first node, and the initial transmission procedure or retransmission procedure.

155. The method as claimed in claim 154, wherein the service type is at least one of inventory, sensor, positioning and command.

156. The method as claimed in claim 154, wherein the at least one first node is identified by a two-step RACH or a four step RACH.

157. An apparatus establishing communication with a device in cellular communication, comprising:
a processor;
a memory storing program instructions which, when executed by the processor, causes the processor to:
receive, by at least one first node, a first trigger message,
wherein the first trigger message comprises a first scheduling information for transmission;
determine, by the at least one first node, plurality of resources configured for transmission;
wherein determining comprises, determining a start time of a resource from the plurality of resources based on the first trigger message and using at least one time offset;
wherein the start time is one of:
the time obtained using the at least one time offset after the time instant of receiving one of the start of the first trigger message and the end of the first trigger message and,
sum of the at least one time offset after the time instant of receiving one of the start of the first trigger message and end of the first trigger message
transmit, by the at least one first node, a first message in at least one resource from the plurality of resources;
wherein the first message comprises a first random number
receive, by the at least one first node, a second message
wherein the second message comprises at least one second random number
transmit, by the at least one first node, a third message, if the at least one second random number contains the first random number.

158. An apparatus establishing communication with a device in cellular communication, comprising:
a processor;
a memory storing program instructions which, when executed by the processor, causes the processor to:
transmit, by at least one second node, a first trigger message comprising first scheduling information for a plurality of resources,
wherein the first scheduling information comprises a first time offset indicating the start time of the plurality of resources and a second time offset indicating the start time of a resource from the plurality of resources,
wherein the start time of the plurality of resources is the time obtained using the first time offset after the time instant of receiving one of the start of the first trigger message and the end of the first trigger message, and,
wherein the start time of the resource from the plurality of resources is the time obtained using the second time offset after one of
the time instant of receiving the start of the first trigger message
the time instant of receiving the end of the first trigger message, and
the start of the plurality of resources
receive, by the at least one second node, at least one first message in at least one resource from the plurality of resources;
wherein the at least one first message comprises at least one first random number
transmit, by the at least one first node, a second message
wherein the second message comprises at least one second random number from the at least one first random number.
